(19) United States
(12) Patent Application Publication
(10) Pub. No.: US 2014/0227570 A1
(43) Pub. Date: Aug. 14, 2014

(54) POWER STORAGE DEVICE

(71) Applicants: Hiroshi Hoshi, Hitachinaka (JP); Tsunemi Aiba, Hitachinaka (JP); Chikara Kikkawa, Hitachinaka (JP); Toshiyuki Yoshida, Hitachinaka (JP)

(72) Inventors: Hiroshi Hoshi, Hitachinaka (JP); Tsunemi Aiba, Hitachinaka (JP); Chikara Kikkawa, Hitachinaka (JP); Toshiyuki Yoshida, Hitachinaka (JP)

(73) Assignee: HITACHI VEHICLE ENERGY, LTD., Hitachinaka-shi, Ibaraki (JP)

(21) Appl. No.: 14/117,262

(22) PCT Filed: May 8, 2012
(86) PCT No.: PCT/JP2012/061730

§ 371 Date: Feb. 11, 2014

(30) Foreign Application Priority Data
May 13, 2011 (JP) 2011-108538

(51) Int. Cl. H01M 10/48; H01M 2/10

(52) U.S. Cl. CPC H01M 10/486; H01M 2/1077; H01M 2220/20
USPC 429/90

(57) ABSTRACT

The present invention is a power storage device including a holding member holding power storage units and temperature detection sensors detecting temperatures of the power storage units held by the holding member, in which the holding member includes a facing surface portion facing coated surfaces of the power storage units held by the holding member, and through holes formed so as to pierce through the facing surface portion, each of the temperature detection sensors includes a lid unit closing the through hole by being attached to the holding member, and a sensor unit supported in the lid unit so as to be elastically deformed, which is elastically deformed when the lid unit closes the through hole, pressed and contacted onto the coated surface of the power storage unit due to reaction force of elastic deformation.

### TECHNICAL FIELD

The present invention relates to a power storage device.

### BACKGROUND ART

The power storage device includes a plurality of power storage units the number of which differs according to a system in which the device is installed. In the plural power storage units, electrical characteristics vary due to heat generation by charging and discharging and the voltage which can be inputted and outputted varies. Accordingly, in the power storage device, plural power storage units are cooled by a coolant as well as the temperature is measured by attaching a temperature sensor on coated surfaces of the power storage units as measurement targets and the temperature of the plural power storage units is managed by taking measurement results in a controller, thereby controlling the cooling of the power storage units by the coolant. Accordingly, the temperature increase of the plural power storage units is suppressed to a given value.

In Patent Document 1, there is disclosed a structure of attaching a temperature sensor in which a temperature sensor having a thermistor as a temperature measuring device is inserted into an attachment hole formed in a module body and a pair of elastic locking pieces of the temperature sensor is engaged with an peripheral edge portion of the attachment hole to elastically deform the elastic locking pieces, thereby allowing a portion contacting a substance in the temperature sensor to contact a battery cell by biasing the battery cell with a given pressing force.

### CITATION LIST

### Patent Literature

[PTL 1] JP-A-2009-250768

### SUMMARY OF INVENTION

### Technical Problem

However, as the attachment hole of the module body is opened in the case of the structure of attaching the temperature sensor as in the background art, there is a potential that the coolant in the module body transmits through the attaching hole and leaks to the outside or that outside air transmits through the attachment hole and flows into the module body, for example, in the structure in which the coolant flows inside the module body. When the coolant or the outside air transmits through the attachment hole, accurate temperature detection by the temperature sensor is disturbed.

The present invention has been made in view of the above, and an object thereof is to provide a power storage device capable of detecting the temperature of power storage units held in a holding member by the temperature sensor accurately.

### Solution of Problem

In order to solve the above problems, for example, the structure described in claims is applied. Though the present application includes plural means for solving the above problems, as one of the means, there is provided a power storage device including a holding member holding power storage units, and temperature detection sensors detecting temperatures of the power storage units held by the holding member, in which the holding member includes a facing surface portion facing coated surfaces of the power storage units held by the holding member, and through holes formed so as to pierce through the facing surface portion, each of the temperature detection sensors includes a lid unit closing the through hole by being attached to the holding member, and a sensor unit supported in the lid unit so as to be elastically deformed, which is elastically deformed when the lid unit closes the through hole, pressed and contacted onto the coated surface of the power storage unit due to reaction force of elastic deformation.

### Advantageous Effects of Invention

According to the typical solution means, for example, the through hole is closed by the lid unit, therefore, in the case of the structure in which the coolant flows between the facing surface portion and the power storage units, it is possible to prevent the coolant from transmitting through the through hole and leaking to the outside or the outside air from transmitting through the through hole and flowing in. Note that problems, structures and advantages other than the above will be clarified by the following explanation of an embodiment. The present specification includes the content described in the specification and/or drawings of Japanese Patent Application No. 2011-108538 as a basis of the priority of the present application.

### BRIEF DESCRIPTION OF DRAWINGS

FIG. 1 is a perspective view showing an external structure of a lithium-ion battery device according to the present embodiment.

FIG. 2 is an exploded perspective view of FIG. 1.

FIG. 3 is a cross-sectional view taken along III-III line of FIG. 1.

FIG. 4 is an enlarged view of a part IV of FIG. 3.

FIG. 5 is an enlarged view of a part V of FIG. 3.

FIG. 6 is a front view of a duct member.

FIG. 7 is a plan view of the duct member.

FIG. 8 is a view showing a state in which plural battery cells are held by a holding case.

FIG. 9 is an exploded perspective view of FIG. 8.

FIG. 10 a cross-sectional view for explaining a joint structure of a lower holding frame member and a middle holding frame member.

FIG. 11 is a cross-sectional view for explaining a joint structure of the middle holding frame member and an upper holding frame member.

FIG. 12 is a perspective view showing an assembly completion state of a cell block.

FIG. 13 is an exploded perspective view for explaining a structure of attaching conductive members and voltage detection substrates.

FIG. 14 is a view showing an example of a method of attaching the voltage detection substrate.

FIG. 15 is a view showing another example of a method of attaching the voltage detection substrate.

FIG. 16 are perspective views showing a shutter structure.

FIG. 17 is a cross-sectional view for explaining the shutter structure.

FIG. 18 is a plan view for explaining a structure of a lower lid portion.

FIG. 19 is a cross-sectional view for explaining a structure of discharging gas in a housing chamber.

FIG. 20 are perspective views showing the upper holding frame member by enlarging a relevant part thereof.

FIG. 21 are perspective views showing the upper holding frame member from the reverse side.

FIG. 22 is a plan view showing the upper holding frame member by enlarging a relevant part thereof.

FIG. 23 are perspective views explaining a structure of a temperature detection sensor.

FIG. 24 is a perspective view showing a cross section in a state in which the temperature detection sensor is attached to the upper holding frame member.

FIG. 25 is a cross section showing an attached state of the temperature detection sensor.

### DESCRIPTION OF EMBODIMENT

Hereinafter, an embodiment of the present invention will be explained in detail with reference to the drawings.

In the present embodiment, a case of a lithium-ion battery device (storage battery device) will be explained as an example of rechargeable battery module.

The lithium-ion battery device according to the embodiment is applied to an in-vehicle power supply in an electric motor driving system of a motor vehicle such as an electric vehicle. A concept of the electric vehicle includes a hybrid electric vehicle having an engine as an internal combustion engine and an electric motor as driving sources of a vehicle, a genuine electric vehicle having the electric motor as an only driving source of a vehicle and so on.

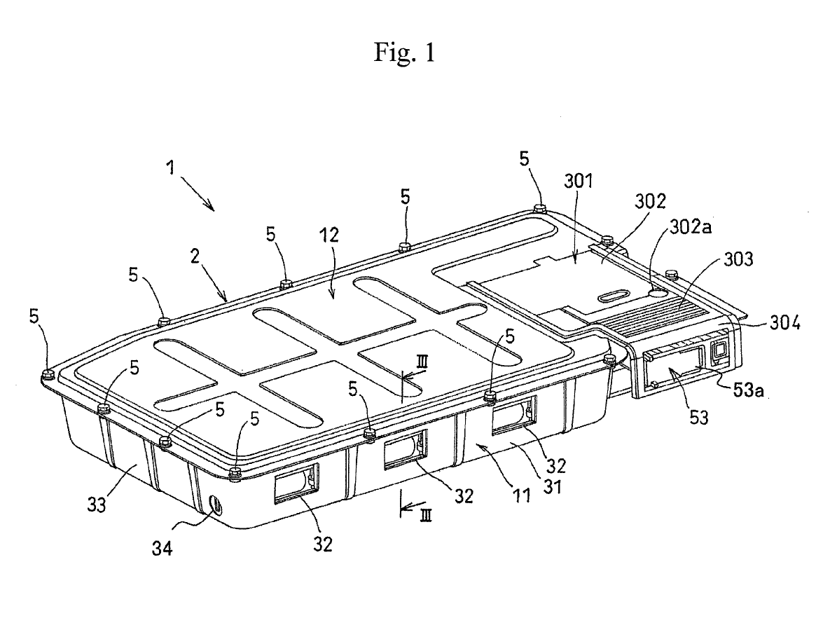

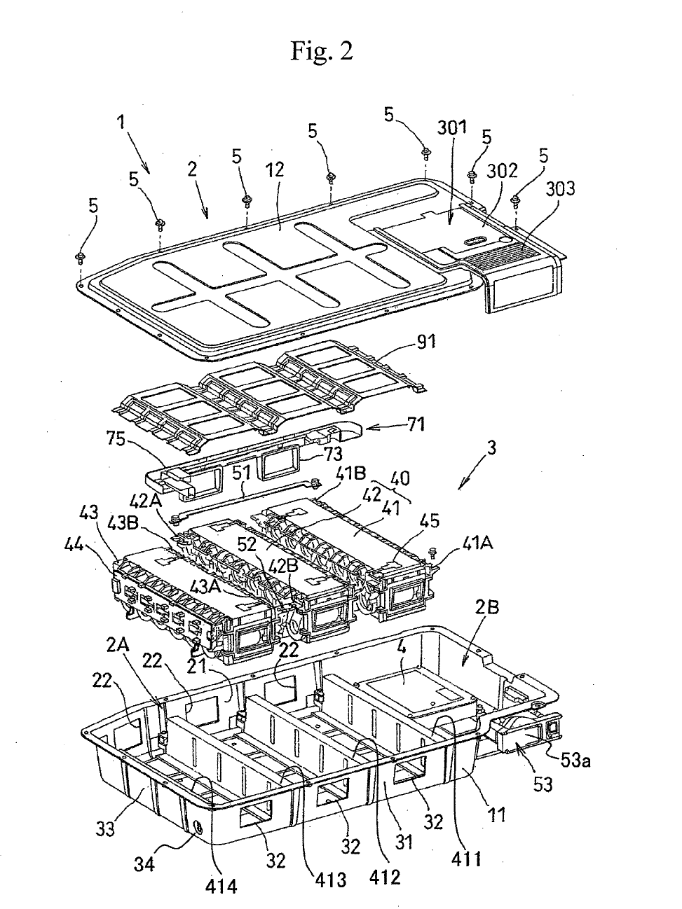

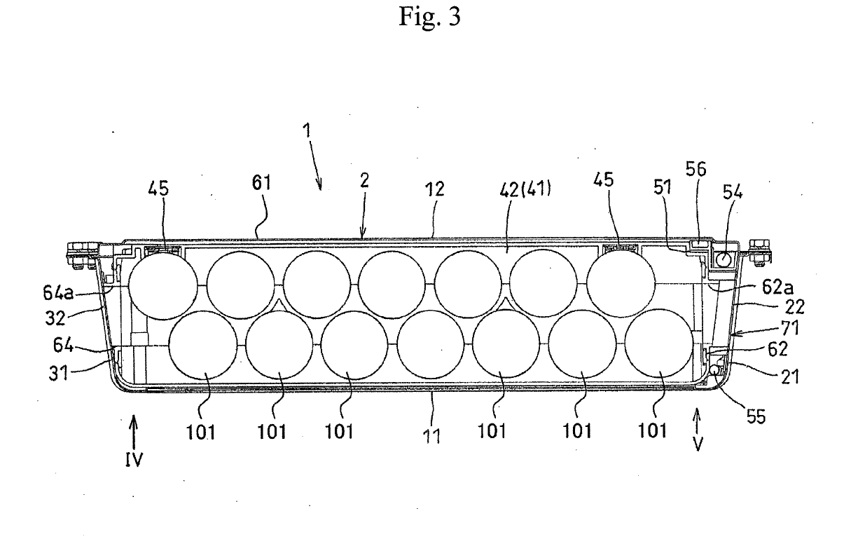

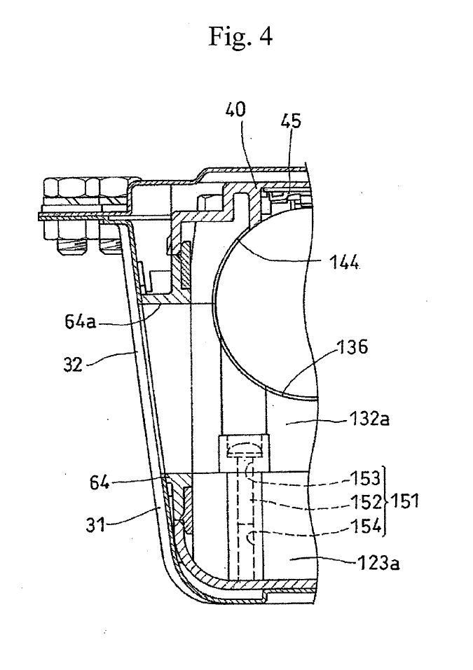

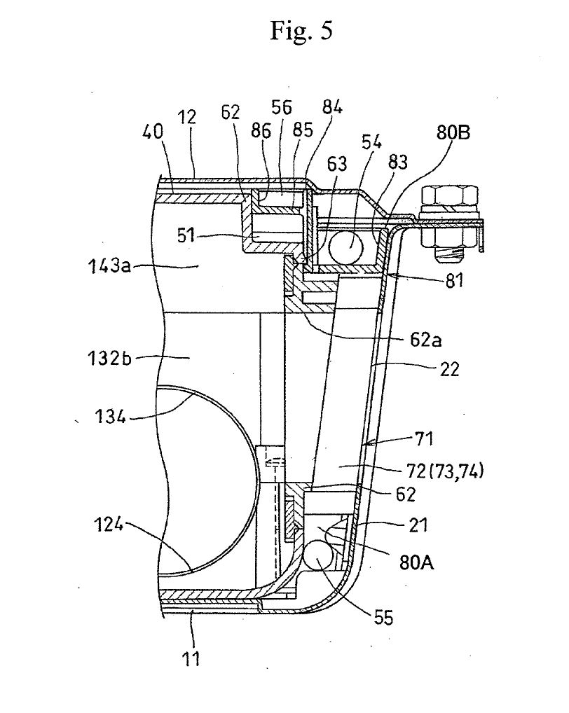

First, the entire structure of the lithium-ion battery device will be explained with reference to FIG. 1 to FIG. 5. FIG. 1 is a perspective view showing an external structure of the lithium-ion battery device, FIG. 2 is an exploded perspective view of FIG. 1, FIG. 3 is a cross-sectional view taken along III-III line of FIG. 1, FIG. 4 is an enlarged view of a part IV of FIG. 3 and FIG. 5 is an enlarged view of a part V of FIG. 3. Explanation will be made by taking an upstream side of cooling air as a front side and taking a downstream side of cooling air as a rear side regardless of an attaching position or direction of the lithium-ion battery device.

The lithium-ion battery device 1 has a structure in which two components of a battery unit 3 and a control unit 4 are housed in a module casing 2. The module casing 2 has a landscape rectangular box shape extending in a flat state, including a lower lid portion 11 and an upper lid portion 12 as shown in FIG. 1 and FIG. 2. The lower lid portion 11 has a shallow dish shape with a given depth and the upper lid portion 12 has a flat-plate shape closing an upper portion of the lower lid portion 11. The upper lid portion 12 and the lower lid portion 11 are formed by pressing a metal thin plate and so on. The lower lid portion 11 has a casing front-wall portion 21 and a casing rear-wall portion 31 facing each other with a space between them in a front and rear direction of the module casing 2. In the casing front-wall portion 21 and the casing rear-wall portion 31, air inlets 22 and exhaust ports 32 for circulating cooling air as a coolant inside cell blocks 40 are provided.

In the module casing 2, a battery unit housing area 2A housing the battery unit 3 is formed on one side in the lateral direction of the module casing 2 and a control unit housing area 2B housing the control unit 4 is formed on the other side in the lateral direction.

The battery unit 3 includes three cell blocks 40 which are a first cell block 41, a second cell block 42 and a third cell block 43. Respective cell blocks 41 to 43 have a block shape with a long axis, which are arranged adjacent to one another in parallel so that longitudinal directions are in parallel to one another. In the present embodiment, the first cell block 41, the second cell block 42 and the third cell block 43 are housed inside the lower lid portion 11 so as to extend in the front and rear direction of the module casing 2, which are arranged side by side in the order from the first cell block 41 to the third cell block 43 toward a direction away from the control unit housing area 2B.

In respective cell blocks 41 to 43, positive-pole terminals 41A to 43A and a negative-pole terminals 41B to 43B are arranged at portions separated on both sides in the longitudinal direction. In the embodiment, the first cell block 41 and the second cell block 42 are arranged in parallel so that an end portion on the positive-pole terminal 41A side of the first cell block 41 faces an end portion on the negative-pole terminal 42B of the second cell block 42 as well as an end portion on the negative-pole terminal 41B side of the first cell block 41 faces an end portion on the positive-pole terminal 42A side of the second cell block 42.

Then, the second cell block 42 and the third cell block 43 are arranged in parallel so that the end portion of the negative-pole terminal 42B of the second cell block 42 faces an end portion of the positive-pole terminal 43A of the third cell block 43 as well as the end portion of the positive-pole terminal 42A of the second cell block 42 faces a negative-pole terminal 43B of the third cell block 43.

Then, the negative-pole terminal 41B of the first cell block 41 and the positive-pole terminal 42A of the second cell block 42, as well as the negative-pole terminal 42B of the second cell block 42 and the positive-pole terminal 43A of the third cell block 43 are electrically connected by bus bars 51 and 52. The second cell block 42 and the third cell block 43 are configured so that both blocks can be electrically connected or disconnected by a SD (service disconnect) switch 53. The SD switch 53 is a safety device provided for securing safety at the time of maintenance and inspection of the lithium-ion battery device 1, including an electric circuit in which a switch and a fuse are electrically connected in series, which is operated by a service man at the time of maintenance and inspection.

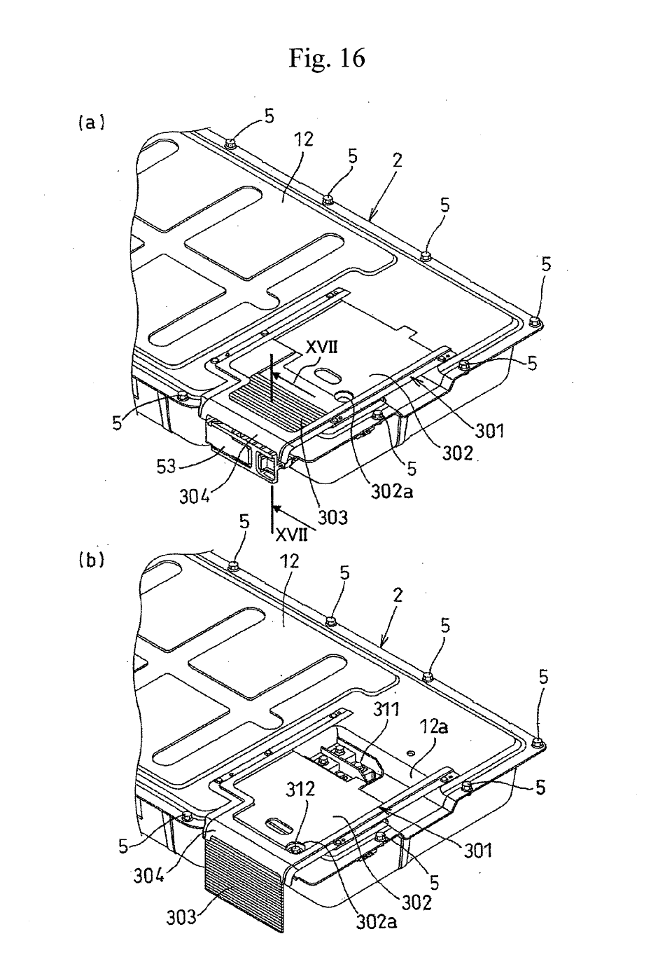

The positive-pole terminal 41A of the first cell block 41 and the negative-pole terminal 43B of the third cell block 43 are connected to an inverter connection terminal 311 (refer to FIG. 16 (b)) as an external terminal of the control unit 4 through a harness 54 (refer to FIG. 3 and FIG. 5). The cell block 40 includes a voltage detection substrate 44 and a temperature detection sensor 45, which are respectively connected to a controller (not shown) of the control unit 4 by a voltage detection wire 55 and a sensor wire 56 (refer to FIG. 3 and FIG. 5) respectively.

The cell block 40 has a structure in which plural battery cells 101 are held in a holding case 61 as shown in FIG. 3, in which coolant circulating ports for circulating the coolant inside the cell block 40 are provided at both end portions thereof. As coolant circulating ports, for example, a coolant introducing port 62a for introducing cooling air into the holding case 61 is provided in a case front-end face portion 62 on one side in the longitudinal direction of the holding case 61, and a coolant lead-out port 64a for leading out cooling air passing through the holding case 61 to the outside of the holding case 61 is provided in a case rear-end face portion 64 on the other side in the longitudinal direction of the holding case 61. Then, a cooling passage is formed inside the holding case 61, which allows cooling air to flow from the coolant introducing port 62a into the holding case 61, to be circulated inside the holding case 61 over the longitudinal direction and to flow out from the coolant lead-out port 64a.

In the cell block 40, the case front-end face portion 62 is arranged so as to face the casing front-wall portion 21 in a state of being housed in the module casing 2, and the coolant introducing port 62a of the case front-end face portion 62 faces the air inlet 22 of the casing front-wall portion 21 as shown in FIG. 5. Then, case rear-end face portion 64 is arranged so as to face the casing rear-wall portion 31 and the coolant lead-out port 64a of the case rear-end face portion 64 faces the exhaust port 32 of the casing rear-wall portion 31 as shown in FIG. 4.

The first cell block 41 and the second cell block 42 are formed so that the length in the longitudinal direction is slightly shorter than a distance between the casing front-wall portion 21 and the casing rear-wall portion 31 of the module casing 2 as shown in FIG. 3. Then, the first cell block 41 and the second cell block 42 are respectively arranged at positions deviated to the casing rear-wall portion 31 side in the module casing 2, and the casing rear-wall portion 31 abuts on the case rear-end face portion 64 as well as the coolant lead-out port 64a of the case rear-end face portion 64 and the exhaust port 32 of the casing rear-wall portion 31 are directly connected as shown in FIG. 4. In this state, the casing rear-wall portion 31 and the case rear-end face portion 64 are closely contacted, which can prevent gas in the module casing 2 from leaking in. Furthermore, it is also preferable that sealant is interposed between the casing rear-wall portion 31 and the case rear-end face portion 64.

Then, as shown in FIG. 3 and FIG. 5, a duct 72 is attached between the casing front-wall portion 21 and the case front-end face portion 62. The duct 72 has a structure of connecting the air inlet 22 of the casing front-wall portion 21 and the coolant introducing port 62a of the case front-end face portion 62, and forming space areas 80A, 80B continuing between the casing front-wall portion 21 and the case front-end face portion 62 as well as below and above the duct 72 (outside of the duct 72) in the lateral direction.

Then, wires using the space areas 80A, 80B as wire passages and connecting the first to third cell blocks 41 to 43 and the control unit 4 are inserted. The wires inserted to the space areas 80A and 80B include the harness 54 connecting the negative-pole terminal 43B of the third cell block 43 and the control unit 4, the voltage detection wire 55 transmitting detection signals of voltages of respective cell blocks 41 to 43 to the control unit 4, the sensor wire 56 transmitting the detection signal of the temperature detection sensor 45 to the control unit 4 and so on.

### <Duct Member>

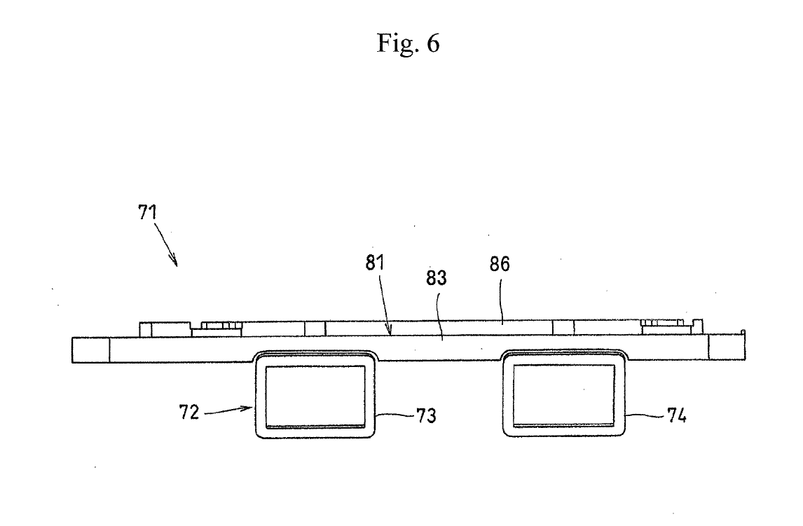

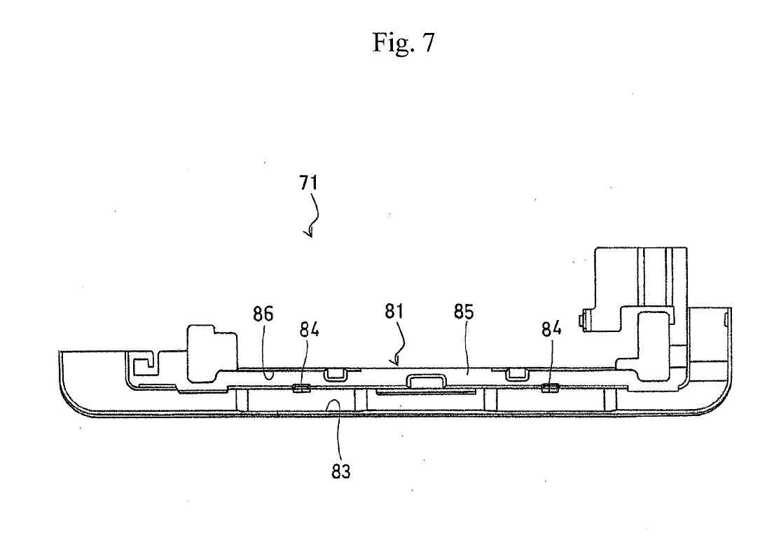

Next, a structure of a duct member according to the embodiment will be explained in detail with reference to FIG. 6 and FIG. 7.

FIG. 6 is a front view of the duct member and FIG. 7 is a plan view of the duct member.

The duct member 71 includes a duct 72 and a duct holder 81 as shown in FIG. 6 and FIG. 7. The duct 72 has a structure of connecting the air inlets 22 of the casing front-wall portion 21 and the coolant introducing port 62a of the case front-end face portion 62 and the duct holder 81 has a structure of holding the duct 72 at the connection position. The duct 72 includes a first duct 73 interposed between the casing front-wall portion 21 and the case front-end face portion 62 of the first cell block 41 and a second duct 74 interposed between the casing front-wall portion 21 and the case front-end face portion 62 of the second cell block 42.

Each of the first duct 73 and the second duct 74 has a frame shape in which an upstream-end face contacts the circumference of the air inlet 22 of the casing front-wall portion 21 and a downstream-end face contacts the circumference of the coolant introducing port 62a of each case front-end face portion 62 of the first cell block 41 and the second cell block 42 as shown in, for example, FIG. 5 and FIG. 6. Then, the ducts 73 and 74 are closely attached to the casing front-wall portion 21 and the case front-end face portion 62, thereby preventing gas in the module casing 2 from leaking in. It is also preferable that a sealant is provided between the duct and the casing front-wall portion 21 and between the duct and the case front-end face portion 62 to perform sealing.

Each of the first duct 73 and the second duct 74 has the size and shape for regulating movement of the cell blocks 41 and 42 in the module casing 2 in the longitudinal direction and positioning the cell blocks 41 and 42. Then, the upper space area 80A and the lower space area 80B continuing in the lateral direction of the module casing 2 are formed over the first cell block 41 and the second cell block 42 between the casing front-wall portion 21 and the case front-end face portion 62 as well as below and above the first duct 73 and the second duct 74. The lower space area 80A has the size in which the voltage detection wire 55 of respective cell blocks 41 to 43 can be wired.

The duct holder 81 has a structure of extending along the upper side of the first duct 73 and the second duct 74 to hold the first duct 73 and the second duct 74 as shown in FIG. 6.

The duct holder 81 has a long-bar shape extending continuously in the lateral direction over the first cell block 41 to the second cell block 42 inside the upper space area 80B as shown in FIG. 5, having a length in which one end is arranged at a position close to the negative-pole terminal 43B of the third cell block 43 and the other end is arranged in the control unit housing area 2B.

The duct holder 81 is attached to the upper space area 80B, thereby positioning and arranging the first duct 73 and the second duct 74 at positions connecting the air inlets 22 of the casing front-wall portion 21 and the coolant introducing port 62a of the case front-end face portion 62.

The duct holder 81 has a first wire passage 83 extending along the longitudinal direction. In the first wire passage 83, a cross section opening toward the upper side has an approximately C-shape groove shape, in which the harness 54 is housed in the present embodiment.

The duct holder 81 is formed so that a front surface faces the casing front-wall portion 21, a rear surface faces the case front-end face portion 62, and concave portions 84 for locking and a flange 85 are provided on the rear surface. The concave portions 84 for locking are locked to the first cell block 41 and the second cell block 42 when the duct member 71 is inserted into a space area between the casing front-wall portion 21 and the case front-end face portion 62 from above, thereby fixing the duct member 71 and suppressing movement of the duct member 71 to the upper side.

The embodiment has a structure in which locking hooks 63 protruding from the case front-end face portion 62 enters the concave portions 84 to be locked, and the duct member 71 can be removed by releasing the lock by the locking hooks 63. Therefore, attaching and removing operations can be easily performed, which facilitates assembly work and maintenance work of the lithium-ion battery device 1.

The flange 85 has a shape of protruding backward from an upper edge of a rear surface of the duct holder 81 along an upper surface of the cell block 40 and extending along the duct holder 81 with a given width, which can cover an upper surface of the bus bar 51. Accordingly, for example, when the serviceman opens the upper lid portion 12 for maintenance work and so on, the exposure of the bus bar 51 is prevented and careless touch to the bus bar 51 can be also provided, as a result, the safety can be secured.

A second wire passage 86 is provided above the flange 85 as shown in FIG. 5. The second wire passage 86 has a shape of a shallow groove extending along the longitudinal direction of the duct holder 81 and opening toward the upper side, in which the sensor wire 56 such as a thermistor wire can be housed and wired in the embodiment.

According to the duct structure having the above components, the space areas 80A, 80B are formed between the casing front-wall portion 21 and the case front-end face portion 62 as well as outside the duct 72, and wires between respective cell blocks 41 to 43 and the control unit 4 can be bundled in the space areas 80A, 80B. Therefore, the entire size of the lithium-ion battery device 1 in the height direction can be reduced as compared with a related-art technique in which wiring is performed above the cell block, which can save space. Accordingly, the embodiment can be applied to a vehicle interior in which, for example, the constraint in the height direction is larger than the constraint in the horizontal direction, which can secure a larger vehicle space.

As respective wires 55, 54 and 56 can be held at fixed positions, it is possible to prevent unreasonable force being affected on joint portions of wires even when the impact such as vibration is added. Therefore, damage and the like at connector portions can be prevented and durability is improved to thereby obtain specifications bearing the use for a long period of time.

The wiring of voltage detection wire 55 can be separated and held in the lower space area 80A just by wiring the voltage detection wire 55 between the casing front-wall portion 21 and the case front-end face portion 62 and mounting the duct member 71, therefore, it is not necessary to fix the voltage detection wire 55 to the lower lid portion 11 or the cell block 40 by using another component and the number of components can be reduced, which facilitates assembly work.

In the above wiring structure, the case in which respective wires of the voltage detection wire 55, the harness 54 and the sensor wire 56 are inserted into the lower space area 80A, the first wire passage 83 and the second wire passage 86 has been explained as the example, however, at least one wire may be inserted, and it is not always necessary that respective wires of the voltage detection wire 55, the harness 54 and the sensor wire 56 are inserted into the lower space area 80A, the first wire passage 83 and the second wire passage 86, and positional replacement to one another may be considered.

### <Cell Block>

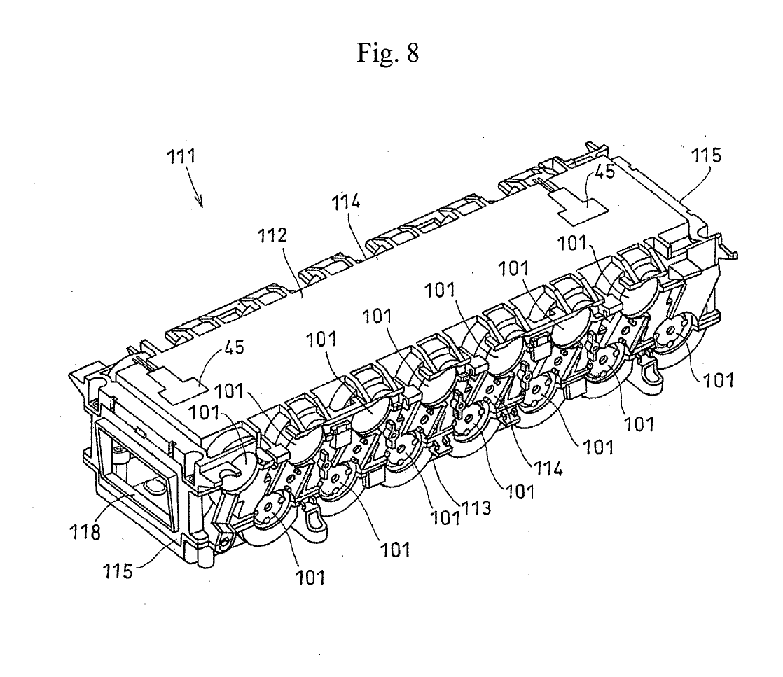

Next, a structure of the cell block in the present embodiment will be explained in detail with reference to FIG. 8 to FIG. 15.

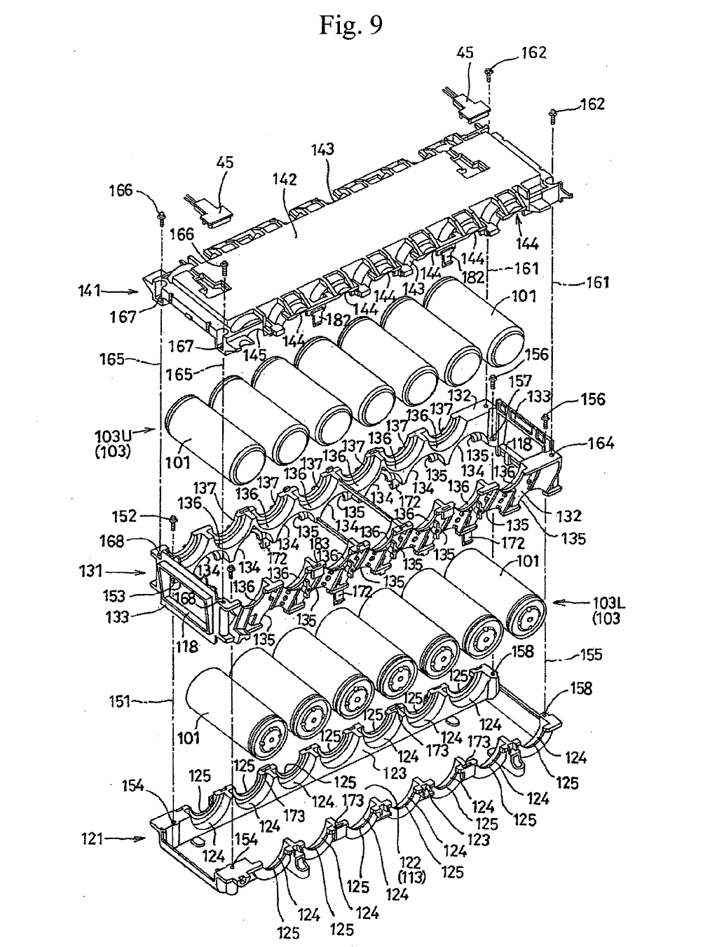

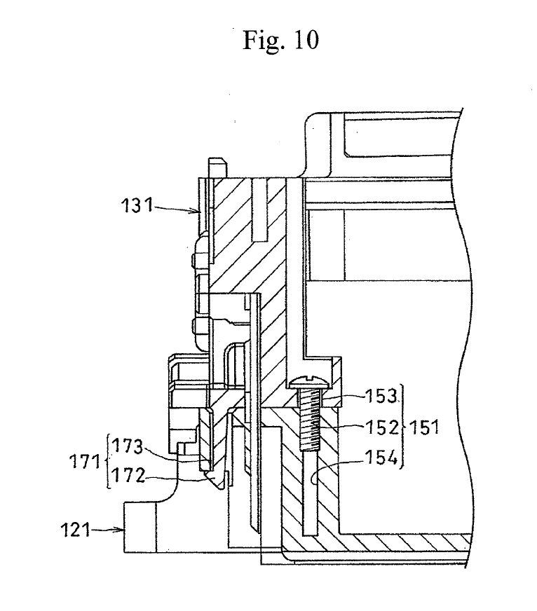

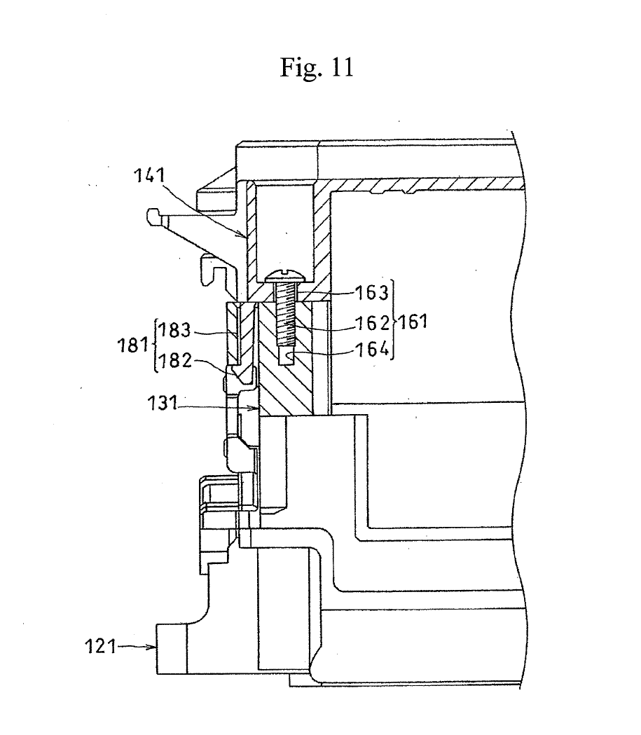

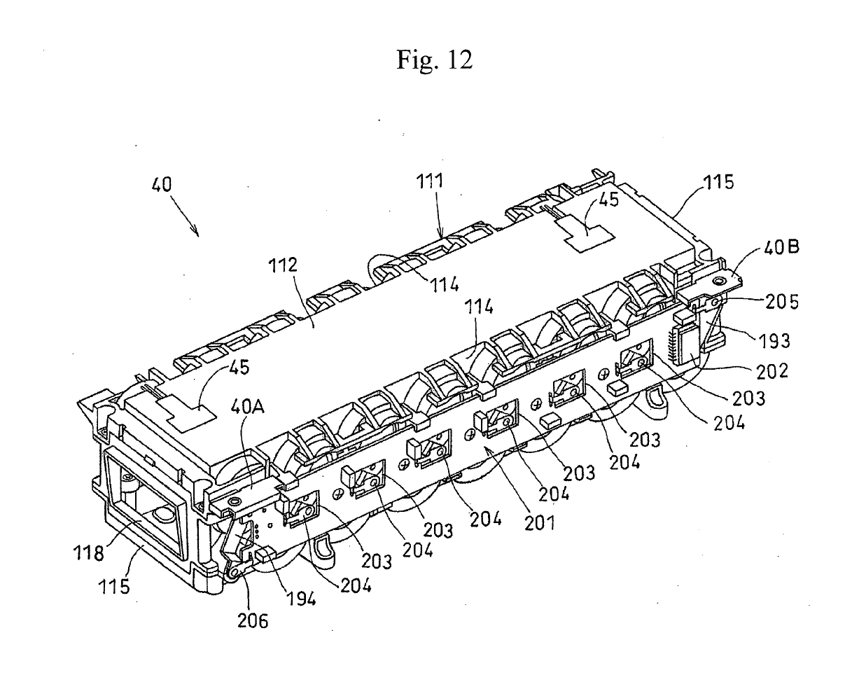

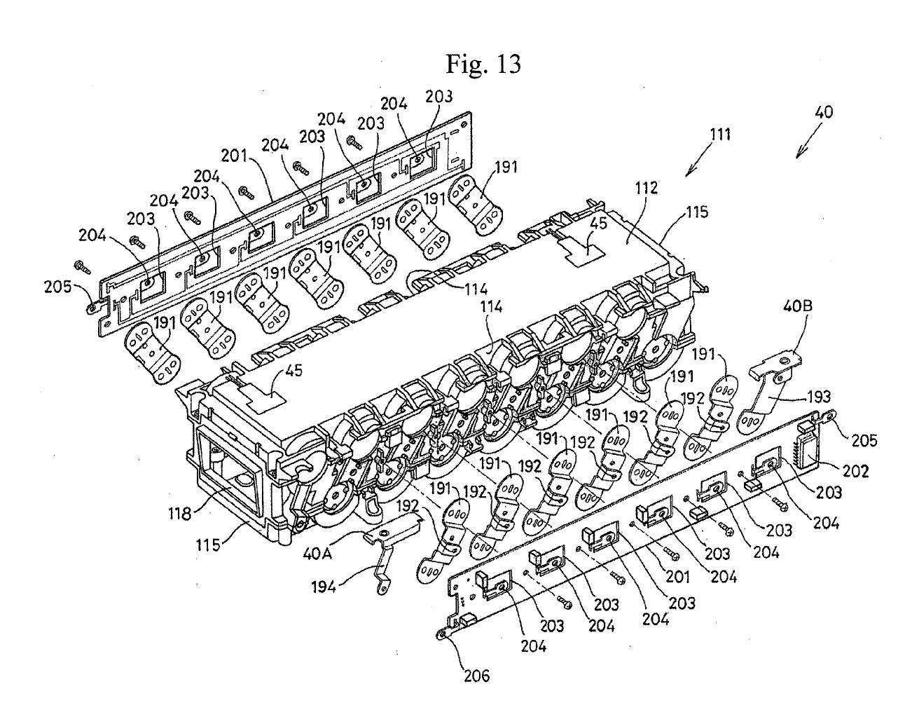

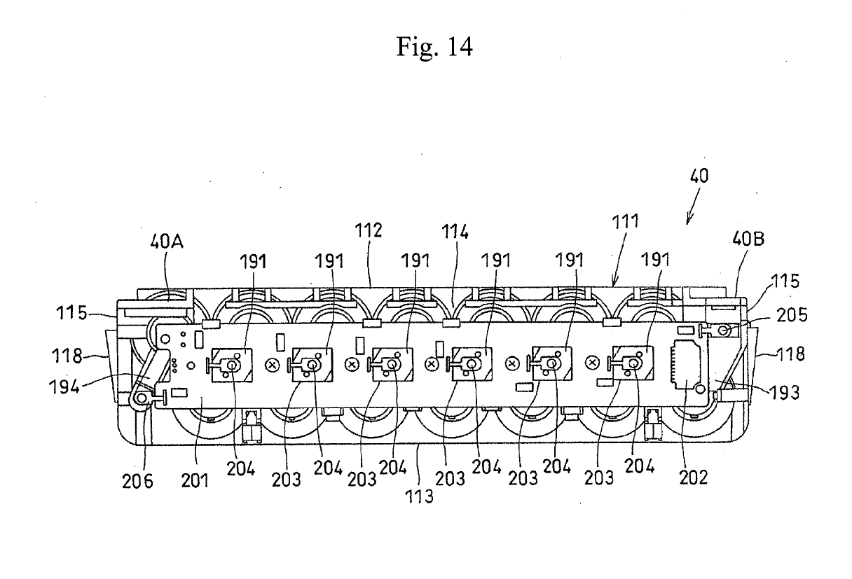

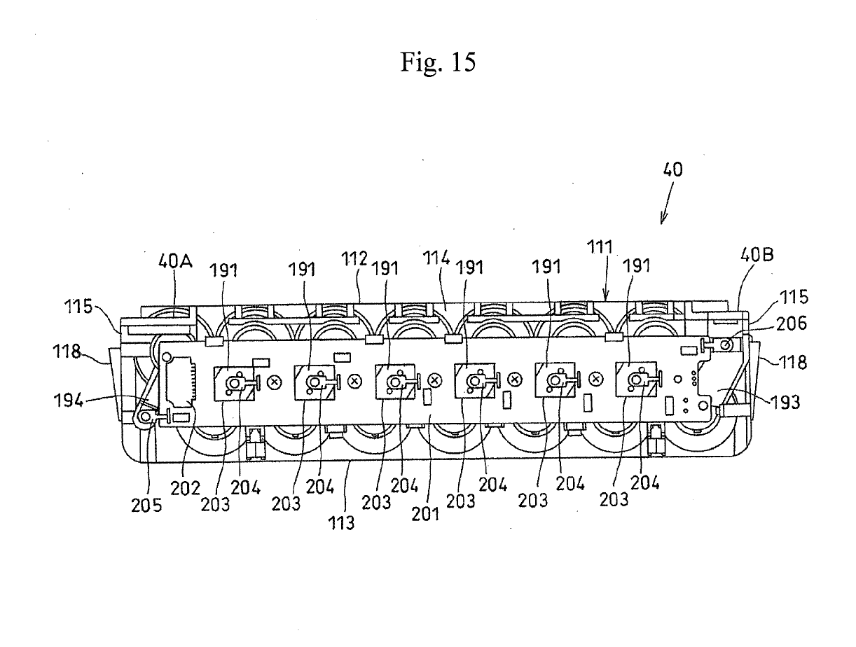

FIG. 8 is a view showing a state in which plural battery cells are held by a holding case, FIG. 9 is an exploded perspective view of FIG. 8, FIG. 10 is a cross-sectional view for explaining a joint structure of the lower holding frame member and a middle holding frame member, FIG. 11 is a cross-sectional view for explaining a joint structure of the middle holding frame member and an upper holding frame member, FIG. 12 is a perspective view showing an assembly completion state of the cell block, FIG. 13 is an exploded perspective view for explaining a structure of attaching conductive members and voltage detection substrates, FIG. 14 is a view showing an example of a method of attaching the voltage detection substrate and FIG. 15 is a view showing another example of a method of attaching the voltage detection substrate.

In the cell blocks 40, the first cell block 41 and the second cell block 42 have the same structure except that an orientation of attaching a voltage detection substrate 201 differs, for example, as shown in FIG. 14 and FIG. 15, which are arranged inside the module casing 2 side by side so that positions of the positive-pole terminals 41A, 42A and the negative-pole terminals 41B, 42B are opposite to each other. On the other hand, the third cell block 43 has a different structure from the first cell block 41 and the second cell block 42 in a point that the number of battery cells 101 is twelve, whereas the number of battery cells 101 in the first and second cell blocks 41 and 42 is respectively fourteen. Then, the orientation and the position in which the third cell block 43 is arranged in the module casing 2 are determined to one type. In the following description, the structure of the cell block 40 will be explained by citing the case of the first cell block 41 and the second cell block 42 as an example.

The cell block 40 has a structure in which a plural number of battery cells 101 are held inside the holding case 111 and respective battery cells 101 are electrically connected in series by conductive members to form an assembled battery. As the battery cells 101, lithium-ion battery cells are used.

The battery cell 101 is a structure body having a cylindrical shape, which is formed by housing components including a cell element, a safety valve and so on inside a battery container filled with an electrolyte. The safety valve on the positive pole side is a cleavage valve to be cleaved when a pressure inside the battery container becomes a given pressure due to an abnormal situation such as overcharge. The safety valve functions as a fuse mechanism shutting off electrical connection between a battery lid and the positive-pole side of the cell element by the cleavage as well as functions as a decompression mechanism for ejecting gas generated inside the battery container, namely, carbon dioxide-based gas (ejecta) in a mist state including the electrolyte to the outside of the battery container.

A cleavage groove is provided also on the negative-pole side of the battery container, which is cleaved when a pressure inside the battery container becomes a given pressure due to an abnormal situation such as overcharge. Accordingly, gas generated inside the battery container can be ejected also from the negative-pole terminal side. A nominal output voltage of the lithium-ion battery cell 101 is 3.0 to 4.2 volt and an average nominal output voltage is 3.6 volt.

The holding case 111 has a hexahedron shape with a long axis as shown in FIG. 8, including an upper surface portion 112 and a lower surface portion 113 vertically facing and apart from each other as well as extending in the longitudinal direction with an approximately fixed width, a pair of vertical wall-surface portions 114, 114 facing and apart from each other in a short side direction as well as extending over respective long edge portions of the upper surface portion 112 and the lower surface portion 113 and a pair of end face portions 115, 115 facing and apart from each other in the longitudinal direction as well as extending over respective short edge portions of the upper surface portion 112, the lower surface portion 113 and the pair of vertical wall-surface portions 114, 114.

The holding case 111 has a structure of including a battery cell arrangement body 103 in which a plural number of battery cells 101 are arranged in parallel in a state of being laid sideways so that the central axes of the battery cells 101 extend along the pair of end face portions 115, 115 as the short side direction of the holding case 111, and holding the battery cell arrangement bodies 103 arranged by being stacked.

The first cell block 41 and the second cell block 42 have a structure of holding seven battery cells 101 in a row direction and two stages or two layers of battery cells 101 in the height direction in a manner of header bond. The third cell block 43 has a structure of holding six battery cells 101 in a row direction and two stages or two layers of battery cells 101 in the height direction in a manner of header bond, though not particularly shown.

A battery cell arrangement body 103L in a lower layer and a battery cell arrangement body 103U in an upper layer are held in a state of being deviated to each other in the row direction, which are held in a state of being deviated by a length corresponding to the half of the battery cell in the longitudinal direction of the holding case 111 in the present embodiment. As the battery cell arrangement body 103L in the lower layer and the battery cell arrangement body 103U in the upper layer are held in the state of being deviated in the row direction, it is possible to allow the battery cell arrangement body 103L in the lower layer and the battery cell arrangement body 103U in the upper layer to be close to each other and the size of the case in the direction orthogonal to the row direction can be shortened. Therefore, the length of the entire assembled battery in the height direction can be reduced and the height of the cell block 40 can be reduced.

The battery cell arrangement body 103L in the lower layer and the battery cell arrangement body 103U in the upper layer are arranged so that orientations of the positive poles and the negative poles of respective battery cells 101 are reversed, in which the positive poles of respective battery cells 101 in the battery cell arrangement body 103L in the lower layer are positioned on one side in the short side direction of the holding case 111, and the negative poles of respective battery cells 101 in the battery cell arrangement body 103U in the upper layer are positioned on the other side in the short side direction of the holding case 111.

The holding case 111 has three members of a lower holding frame member 121, a middle holding frame member 131 and an upper holding frame member 141. The battery cell arrangement body 103L in the lower layer is sandwiched and held by the lower holding frame member 121 and the middle holding frame member 131, and the battery cell arrangement body 103U in the upper layer is sandwiched and held by the middle holding frame member 131 and the upper holding frame member 141.

In the holding case 111, a cooling passage in which respective battery cells 101 are exposed and extending in the longitudinal direction is formed inside the case, and openings 118, 118 respectively connecting to both end portions of the passage portion are formed on the pair of end face portions 115, 115 forming the case front-end face portion 62 and the case rear-end face portion 64 of the holding case 111 in an assembly state.

In respective openings 118, 118, one opening 118 will be the coolant introducing port 62a or the coolant lead-out port 64a and the other opening 188 will be the coolant lead-out port 64a or the coolant introducing port 62a (refer to FIG. 3 to FIG. 5) depending on the direction in which the cell block 40 is attached inside the module casing 2, namely, depending on whether the cell block 40 is used as the first cell block 41 or the second cell block 42. In the present embodiment, the opening 118 on the positive-pole terminal 41A side is the coolant introducing port 62a and the opening 118 on the negative-pole terminal 41B side is the coolant lead-out port 64a in the first cell block 41, and the opening 118 on the negative-pole terminal 42B side is the coolant introducing port 62a and the opening 118 on the positive-pole terminal 42A side is the coolant lead-out port 64a in the second cell block 42.

The lower holding frame member 121 includes a lower surface portion 122 having a flat-plate shape extending with a fixed width and a pair of lower vertical-wall surface portions 123, 123 facing to each other so as to stand upward from both-side ends in the short side direction of the lower surface portion 122. The lower surface portion 122 of the lower holding frame member forms the lower surface portion 113 of the holding case 111 and the lower vertical-wall surface portions 123, 123 form lower portions of the vertical wall-surface portions 114, 114 of the holding case 111.

In the pair of lower vertical-wall surface portion 123, 123, there are provided lower-layer lower holding portions 124 respectively holding lower portions of the battery cells 101 included in the battery cell arrangement body 103L in the lower layer and opening window portions 125 respectively exposing end faces of both sides in the central-axis direction of the battery cells 101 held by the lower-layer lower holding portions. Respective lower-layer lower holding portions 124 have lower-layer lower depressed surfaces cut out in a semicircular-arch shape from upper edge portions of the lower vertical-wall surface portions 123, 123 toward the lower surface portion 122 so as to contact outer peripheral surfaces of end portions of the battery cells 101 and opposite surfaces facing the end faces in the central-axis direction of the battery cells 101, which form a lower holding portion holding the battery cell arrangement body 103L in the lower layer in a state of regulating movement of the battery cells 101 to the central-axis direction and a radial direction in cooperation with later-described lower-layer upper holding portions 134 of middle vertical-wall surface portions 132, 132.

The opening window portions 125 are formed so as to open in the lower vertical-wall surface portions 123, 123, which allow central portions of the end faces of the battery cells 101 held by the lower-layer lower holding portions 124 to be exposed to lateral directions of the holding case 111.

The middle holding frame member 131 includes a pair of middle vertical-wall surface portions 132, 132 extending with a fixed height width and facing to each other and a pair of end face portions 133, 133 provided over short edge portions on both ends in the longitudinal direction of the middle vertical-wall surface portions 132, 132. The middle holding frame member 131 is connected in a stacked manner on the lower holding frame member 121, thereby connecting respective middle vertical-wall surface portions 132, 132 continuously over the respective lower vertical-wall surface portions 123, 123 of the lower holding frame member 121, which form the central portion in the height direction of the vertical wall-surface portions 114, 114 of the holding case 111. Then, the respective end face portions 133, 133 of the middle holding frame members 131, 131 form the respective end face portions 115, 115 of the holding case 111.

In the pair of middle vertical-wall surface portions 132, 132, there are provided lower-layer upper holding portions 134 respectively holding upper portions of the battery cells 101 held by the lower holding frame member 121 and upper-layer lower holding portions 136 respectively holding lower portions of battery cells included in the battery cell arrangement body in the upper layer. Additionally, there are provided opening window portions 135, 137 respectively exposing end faces of both sides in the central-axis direction of the battery cells 101 held by the lower-layer upper holding portions 134 and end faces of both sides in the central-axis direction of the battery cells 101 held by the upper-layer lower holding portions 136.

Respective lower-layer upper holding portions 134 have lower-layer upper depressed surfaces cut out in a semicircular-arch shape from lower edge portions of the middle vertical-wall surface portions 132, 132 toward upper surface portions so as to contact outer peripheral surfaces of the end portions of the battery cells 101 and opposite surfaces facing the end faces in the central-axis direction of the battery cells 101, which form the lower holding portion holding the battery cell arrangement body 103L in the lower layer in a state of regulating movement of the battery cells 101 to the central-axis direction and the radial direction in cooperation with the lower-layer lower holding portions 124 of the lower holding frame member 121.

Respective upper-layer lower holding portions 136 have upper-layer lower depressed surfaces cut out in a semicircular-arch shape from upper edge portions of the middle vertical-wall surface portions 132, 132 toward lower surface portions so as to contact outer peripheral surfaces of the end portions of the battery cells 101 and opposite surfaces facing the end faces in the central-axis direction of the battery cells 101, which form an upper holding portion holding the battery cell arrangement body 103U in the upper layer in a state of regulating movement of the battery cells 101 to the central-axis direction and the radial direction in cooperation with later-described upper layer upper holding potions 144 of the upper holding frame member 141.

As the battery cell arrangement body 103L in the lower layer and the battery cell arrangement body 103U in the upper layer are held in the state of being deviated to each other in the row direction, the respective lower-layer upper holding portions 134 and the respective upper-layer lower holding portions 136 are arranged at positions deviated to each other by the half of the cell in the longitudinal direction of the middle holding frame member 131, and the center of each upper-layer lower holding portion is positioned between the lower-layer upper holding portions 134 adjacent to each other. Additionally, the height of the middle vertical-wall surface portions 132 is shorter than a diameter of the battery cells 101.

The upper holding frame member 141 includes an upper surface portion 142 having flat-plate shape extending with a fixed width and a pair of upper vertical-wall surface portions 143, 143 facing each other so as to come down from both-side ends in a short side direction of the upper surface portion 142. The upper surface portion 142 of the upper holding frame member 141 forms the upper surface portion 112 of the holding case 111, and the upper vertical-wall surface portions 143, 143 form upper portions of the vertical wall-surface portions 114 of the holding case 111.

In the pair of upper vertical-wall surface portions 143, 143, there are provided upper-layer upper holding portions 144 respectively holding upper portions of the battery cells 101 included in the battery cell arrangement body 103U in the upper layer and opening window portions 145 respectively exposing end faces of both sides in the central-axis direction of the battery cells 101 held by the upper-layer upper holding portions 144.

Respective upper-layer upper holding portions 144 have upper-layer upper depressed surfaces cut out in a semicircular-arch shape from lower edge portions of the upper vertical-wall surface portions 143, 143 toward the upper surface portion 142 so as to contact outer peripheral surfaces of the end portions of the battery cells 101 and opposite surfaces facing the end faces in the central-axis direction of the battery cells 101, which form the upper holding portion holding the battery cell arrangement body 103U in the upper layer in a state of regulating movement of the battery cells 101 to the central-axis direction and the radial direction in cooperation with the upper-layer lower holding portions 136 of the middle holding frame member 131.

The opening window portions 145 are formed so as to open in the lower vertical-wall surface portion 143, 143, which allow central portions of the end faces of the battery cells 101 held by the upper-layer upper holding portions 144 to be exposed to lateral directions of the protective case 111.

The holding case 111 includes a lower coupling means for coupling the lower holding frame member 121 to the middle holding frame member 131, and an upper coupling means for coupling the middle holding frame member 131 to the upper holding frame member 141. The lower holding frame member 121 and the middle holding frame member 131 are coupled to each other in a state in which the middle holding frame member 131 is stacked on the lower holding frame member 121 by the lower coupling means. The middle holding frame member 131 and the upper holding frame member 141 are coupled to each other in a state in which the upper holding frame member 141 is stacked on the middle holding frame member 131 by the upper coupling means.

The lower coupling means includes lower fastening portions 151, 155 and lower locking portions 171, and the upper coupling means includes upper fastening portions 161, 165 and an upper locking portion 181.

The lower fastening portions 151, 155 are provided apart from each other at both end portions in the longitudinal direction of the holding case 111 while forming pairs in the short side direction as shown in FIG. 9, and the lower locking portions 171 are provided in a pair in the short side direction at positions close to the center in the longitudinal direction.

The lower fastening portions 151, 155 include lower fastening screws 152, 156, screw through holes 153, 157 formed through the middle holding frame member 131 and threaded holes 154, 158 drilled in the lower holding frame member 121, coupling the lower holding frame member 121 to the middle holding frame member 131 by attaching the lower fastening portions 152, 156 from above the middle holding frame member 131 in a state in which the middle holding frame member 131 is stacked on the lower holding frame member 121 (only the lower fastening portion 151 is shown in FIG. 10).

The lower fastening portion 151 is provided on the positive-pole terminal 40A side (refer to FIG. 12) as one side in the longitudinal direction of the holding case 111. The lower fastening portion 151 is arranged below the battery cell 101 in the battery cells 101 included in the battery cell arrangement body 103U in the upper layer, which protrudes to one side in the row direction with respect to the battery cell arrangement body 103L in the lower layer, which couples the lower holding frame member 121 to the middle holding frame member 131 by fastening.

That is, the lower fastening portion 151 is arranged on the side where the battery cell arrangement body 103U in the upper layer protrudes in the row direction with respect to the battery cell arrangement body 103L in the lower layer, and the screw through hole 153 and the threaded hole 154 are arranged below the upper-layer lower holding portion 136 positioned on the outmost side in the longitudinal direction of the middle holding frame member (refer to, for example, FIG. 4).

As described above, the lower-layer upper holding portions 134 of the middle holding frame member 131 are formed at positions deviated by the half of the battery cell 101 to the negative-pole terminal 40B side with respect to the upper-layer lower holding portions 136, namely, to the side where the battery cell arrangement body 103L in the lower layer protrudes in the row direction with respect to the battery cell arrangement body 103U in the upper layer, and a middle vertical wall portion 132a where the lower-layer upper holding portion 134 of the middle holding frame member 131 does not exist for a length corresponding to approximately the half of the battery cell 101 is formed in a position below the upper-layer lower holding portion 136 positioned closest to the positive-pole terminal 40A side in the middle holding frame member 131. Then, a lower vertical wall portion 123a where the lower-layer lower holding portion 124 does not exist is continuously formed also in the lower holding frame member 121 under the middle holding frame member 131.

Accordingly, as the lower fastening portion 151 is provided in the middle vertical wall portion 132a and the lower vertical wall portion 123a, it can be prevented that the lower fastening portion 151 is provided on the outer side of the upper-layer lower holding portion 136 positioned closest to the positive-pole terminal side in the longitudinal direction of the middle holding frame member 131, namely, on a position further outside the battery cell 101 protruding in the row direction.

Therefore, the length in the longitudinal direction of the holding case 111 can be reduced as compared with a case where the three holding frame members of the lower holding frame member 121, the middle holding frame member 131 and the upper holding frame member 141 are fastened together by one screw by vertically piercing these members. Accordingly, the cell block 40 can be reduced in size, and a space area for wiring can be formed between the casing front-wall portion 21 and the case front-end face portion 62.

The lower locking portion 171 includes a middle locking hook 172 protruding downward from the middle holding frame member 131 and a lower locking hole 173 formed in the lower holding frame member 121, having a structure in which the middle holding frame member 131 is stacked on the lower holding frame member 121 and the middle locking hook 172 is inserted into the lower locking hole 173 to be locked to thereby couple the lower holding frame member 121 and the middle holding frame member 131 to each other as shown in FIG. 10.

The upper fastening portions 161, 165 are provided apart from each other at both end portions in the longitudinal direction of the holding case 111 while forming pairs in the short side direction as shown in FIG. 9, and the upper locking portions 181 are provided in a pair in the short side direction at positions close to the center in the longitudinal direction.

The upper fastening portions 161, 165 include upper fastening screws 162, 166, screw through holes 163, 167 formed through the upper holding frame member 141 and threaded holes 164, 168 drilled in the middle holding frame member 131, coupling the middle holding frame member 131 to the upper holding frame member 141 by attaching the upper fastening screws 162, 166 from above the upper holding frame member 141 in a state in which the upper holding frame member 141 is stacked on the middle holding frame member 131 (only the upper fastening portion 161 is shown in FIG. 11).

The upper fastening portion 161 is provided on the negative-pole terminal 40B side (refer to FIG. 12) as the other side of the holding case 111 in the longitudinal direction. The upper fastening portion 161 is arranged above the battery cell 101 in the battery cells 101 included in the battery cell arrangement body 103L in the lower layer, which protrudes to the other side in the row direction with respect to the battery cell arrangement body 103U in the upper layer, which couples the middle holding frame member 131 to the upper holding frame member 141 by fastening.

That is, the upper fastening portion 161 is arranged on the side where the battery cell arrangement body 103L in the lower layer protrudes in the row direction with respect to the battery cell arrangement body 103U in the upper layer, and the screw through hole 163 and the threaded hole 164 are arranged above the lower-layer upper holding portion 134 positioned on the outmost side in the longitudinal direction of the middle holding frame member 131.

As described above, the upper-layer lower holding portions 136 of the middle holding frame member 131 are formed at positioned deviated by the half of the battery cell 101 to the positive-pole terminal 40A side with respect to the lower-layer upper holding portions 134 in the middle holding frame member 131, namely, to the side where the battery cell arrangement body 103U in the upper layer protrudes in the row direction with respect to the battery cell arrangement body 103L in the lower layer, and a middle vertical wall portion 132b (refer to FIG. 5) where the upper-layer lower holding portion 136 of the middle holding frame member 131 does not exist for a length corresponding to approximately the half of the battery cell 101 is formed in position above the lower-layer upper holding portion 134 positioned closest to the negative-pole terminal 40B side in the middle holding frame member 131. Then, an upper vertical wall portion 143a (refer to FIG. 5) where the upper-layer upper holding portion 144 does not exist is formed also in the upper holding frame member 141 above the middle holding frame member 131.

Accordingly, as the upper fastening portion 161 is provided in the middle vertical wall portion 132b and the upper vertical wall portion 143a, it can be prevented that the upper fastening portion 161 is provided on the outer side of the lower-layer upper holding portion 134 positioned closest to the negative-pole terminal 40B side in the longitudinal direction of the middle holding frame member 131, namely, on a position further outside the battery cell 101 protruding in the row direction.

Therefore, the length in the longitudinal direction of the holding case 111 can be reduced as compared with a case where the three holding frame members of the lower holding frame member 121, the middle holding frame member 131 and the upper holding frame member 141 are fastened together by one screw by vertically piercing these members. Accordingly, the cell block 40 can be reduced in size, and a space area for wiring can be formed between the casing front-wall portion 21 and the case front-end face portion 62.

The upper locking portion 181 includes an upper locking hook 182 protruding downward from the upper holding frame member 141 and a middle locking hole 183 formed in the middle holding frame member 131, having a structure in which the upper holding frame member 141 is stacked on the middle holding frame member 131 and the upper locking hook 182 is locked to the middle locking hole 183 to thereby couple the middle holding frame member 131 to the upper holding frame member 141 to each other as shown in FIG. 11.

Next, a method of assembling the holding case 111 having the above structure will be explained as follows.

First, the battery cells 101 are inserted from the upper direction of the lower holding frame member 121 to be respectively held by the respective lower-layer lower holding portions 124. The respective battery cells 101 are held in line so that positive poles of the respective battery cells 101 are positioned on one side in the short side direction of the holding case 111, which forms the battery cell arrangement body 103L in the lower layer.

Next, the middle holding frame member 131 is stacked on the lower holding frame member 121, and the middle locking hook 172 of the lower locking portion 171 is inserted into the lower locking hole 173 to be locked. Then, the lower fastening screw 152 of the lower fastening portion 151 is inserted into the screw through hole 153 of the middle holding frame member 131 from above the middle holding frame member 131 to be screwed and fastened in the threaded hole 154 of the lower holding frame member 121. Accordingly, the lower holding frame member 121 and the middle holding frame member 131 are coupled to each other in a state of holding the battery cells 101 between the lower holding frame member 121 and the middle holding frame member 131.

Then, the battery cells 101 are inserted from the upper direction of the middle holding frame member 131 to be respectively held by the respective upper-layer lower holding portions 136 of the middle holding frame member 131. The respective battery cells 101 are held in line so that positive terminals of the respective battery cells 101 are positioned on the other side in the short side direction of the holding case 111.

Subsequently, the upper holding frame member 141 is stacked on the middle holding frame member 131, and the upper locking hook 182 of the upper locking portion 181 is inserted into the middle locking hole 183 to be locked. Then, the upper fastening screw 162 of the upper fastening portion 161 is inserted into the screw through hole 163 of the upper holding frame member 141 from above the upper holding frame member 141 to be screwed and fastened in the threaded hole 164 of the middle holding frame member 131. Accordingly, the middle holding frame member 131 and the upper holding frame member 141 are coupled to each other in a state of holding the battery cells 101 between the middle holding frame member 131 and the upper holding frame member 141.

According to the method of assembling the holding case 111, the holding case 111 can be sequentially assembled from the lower portion to the upper portion without turning the lower holding frame member 121, the middle holding frame member 131 and the upper holding frame member 141 upside down in the middle of assembling the holding case 111. Therefore, the cell block 40 can be easily assembled and manufacturing costs can be reduced as the man hour is reduced.

After the holding case 111 is assembled to be the state shown in FIG. 8, conductive members 191 and voltage detection substrates 201 are sequentially attached to the cell block 40.

The conductive members 191 electrically connect the respective battery cells 101 held in the holding case 111 in series to be the assembled battery, which are attached to the vertical wall-surface portions 114, 114 on both sides of the holding case 111 as shown in FIG. 13.

Then, one end is electrically connected to the end portion of each battery cell 101 in the lower layer, and the other end is electrically connected to the end portion of each battery cell 101 in the upper layer positioned diagonally above the each battery cell 101 in the lower layer in the longitudinal direction. A connection terminal 192 for electrically connecting to a voltage detection terminal of the voltage detection substrate is provided at approximately the central position of the conductive member 191.

The positive-pole terminal 40A of the cell block 40 is connected to an electrode of the battery cell 101 in the battery cell arrangement body 103U in the upper layer, which is arranged at the position protruding in the longitudinal direction with respect to the battery cell arrangement body 103L in the lower layer. Then, the negative-pole terminal 40B of the cell block 40 is connected to an electrode of the battery cell 101 in the battery cell arrangement body 103L in the lower layer, which is arranged at the position protruding in the longitudinal direction with respect to the battery cell arrangement body 103U in the upper layer.

After the respective conductive members 191 are attached, the voltage detection substrates 201 are respectively attached along the vertical wall-surface portions 114, 114 on both sides of the holding case 111 so as to overlap these conductive members 191. In the embodiment, the voltage detection substrates 201 are screwed to the holding case 111.

The voltage detection substrate 201 includes voltage detection circuits detecting voltages of respective battery cells 101. The voltage detection substrate 201 has, for example, a band-plate shape extending with a fixed width, in which a connector 202 for connecting the voltage detection wire 55 is provided at one end portion of the voltage detection substrate 201.

In the voltage detection substrate 201, openings 203 are respectively formed at portions facing to approximately the central portions of respective conductive members 191 in a state of being attached to the vertical wall-surface portion 114. In respective openings 203, voltage detection terminals 204 electrically connected to the connection terminals 192 of the conductive members 191 are provided in a protruding manner.

The voltage detection terminals 204 are respectively arranged at positions facing approximately the central positions of respective conductive members 191 so as to be connected to respective conductive members 191 even when the voltage detection substrates 201 are attached in a state of replacing one side and the other side in the longitudinal direction by turning over the voltage detection substrates 201 in the longitudinal direction.

Then, a first connection terminal 205 which can be electrically connected to one of the positive-pole terminal 40A and the negative-pole terminal 40B is provided at one end portion of the voltage detection substrate 201, and a second connection terminal 206 connected to the other of the positive-pole terminal 40A and the negative-pole terminal 40B is provided at the other end portion of the voltage detection substrates 201.

The first connection terminal 205 and the second connection terminal 206 are positioned so as to be respectively connected to the positive-pole terminal 40A and the negative-pole terminal 40B even when the voltage detection substrates 201 are turned over in the longitudinal direction to be attached.

For example, when the cell block 40 is used as the first cell block 41, the cell block 41 is arranged so that the negative-pole terminal 40B side is on the duct member 71 side as the case front-end face portion 62 (refer to FIG. 3). Accordingly, the voltage detection substrate 201 is attached so that the connector 202 is arranged on the negative-pole terminal 40B side which is on the duct member 71 side as shown in FIG. 14. Also in the other vertical wall-surface portion 114 not shown in FIG. 14, the voltage detection substrate 201 is attached so that the connector 202 is arranged on the negative-pole terminal 40B side.

When the voltage detection substrate 201 is attached so that the connector 202 is arranged on the negative-pole terminal 40B side as described above, the first connection terminal 205 is arranged and connected at a position facing a connection portion 193 connecting between the negative-pole terminal 40B and the battery cells 101 in the lower layer. Additionally, the second connection terminal 206 is arranged and connected at a position facing an extended portion 194 extending downward from the positive-pole terminal 40A, connected to the battery cells 101 in the upper layer and further extending downward.

On the other hand, when the cell block 40 is used as the second cell block, the second cell block is arranged so that the positive-pole terminal 40A side is on the duct member 71 side as the case front-end face portion 62. Accordingly, the voltage detection substrate 201 is attached so that the connector 202 is arranged on the positive-pole terminal 40A side which is the duct holder side as shown in FIG. 15.

When the voltage detection substrate 201 is attached so that the connector 202 is arranged on the positive-pole terminal 40A side, the first connection terminal 205 is arranged and connected at the position facing the extended portion 194 of the positive-pole terminal 40A. Additionally, the second connection terminal 206 is arranged and connected at the position facing the connection portion 193 of the negative-pole terminal 40B.

According to the above structure, the voltage detection substrate 201 is interchangeable in attachment in the front and rear direction and a dedicated one is not necessary, therefore, the number of component types can be reduced and manufacturing costs can be reduced.

A different point between the structure of the third cell block 43 and the structure of the first cell block 41 and the second cell block will be briefly explained. The third cell block 43 has twelve battery cells and the length of the holding casein the longitudinal direction is formed to be shorter than the first cell block and the second cell block.

Additionally, in the case front end face portion as the negative-pole terminal 43B side, an extension duct for extending a coolant introducing port to the front direction is integrally formed, though not shown, which is attached inside the module casing 2, thereby allowing a front end portion of the extension duct to abut on the casing front-wall portion 21 and to connect to the air inlet 22 as well as allowing the case rear-end face portion to abut on the casing rear-wall portion 31 and to connect to the exhaust port 32.

### <Structure of Attaching Temperature Detection Sensor>

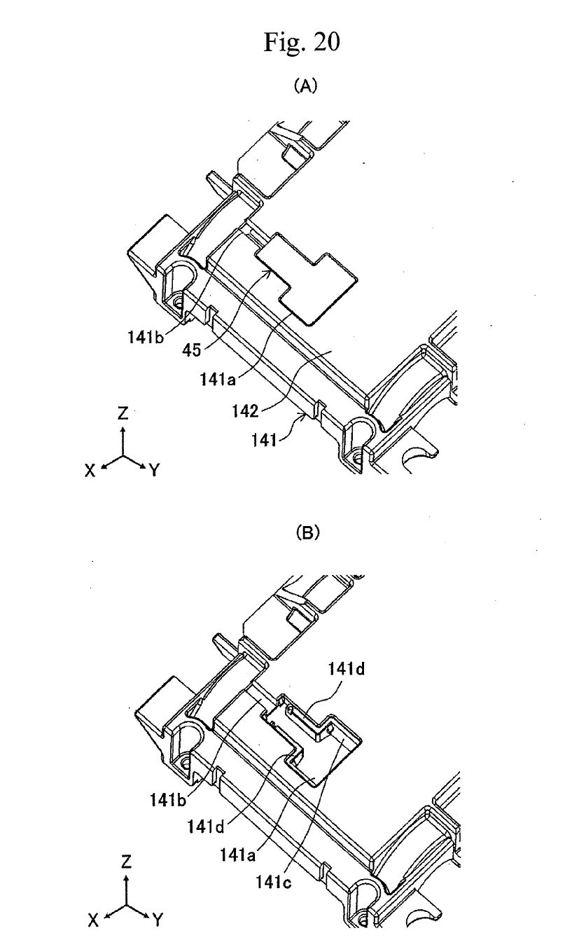

Next, a structure of attaching the temperature detection sensor 45 according to the embodiment will be explained with reference to FIG. 20 to FIG. 25.

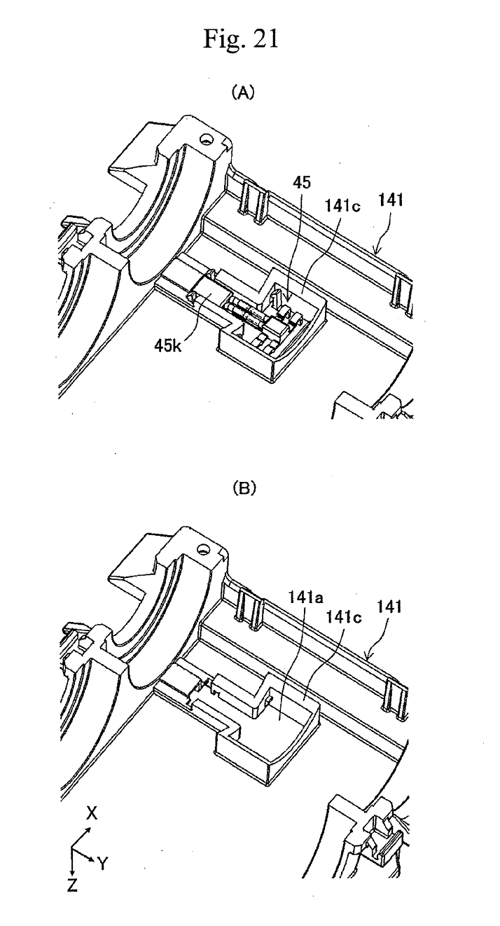

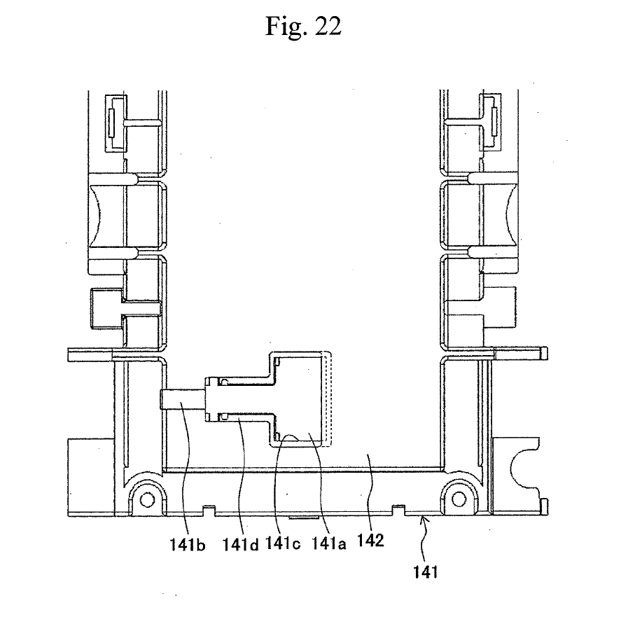

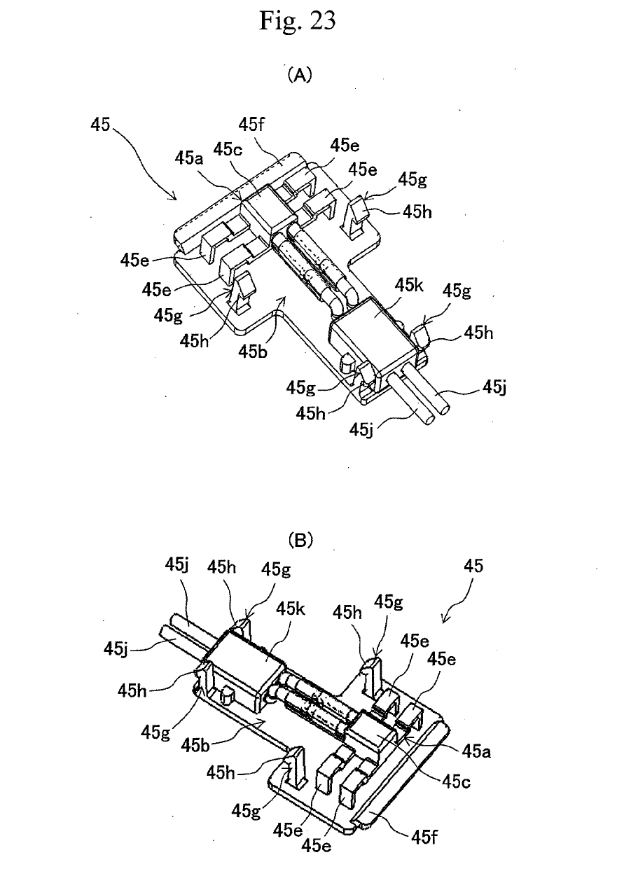

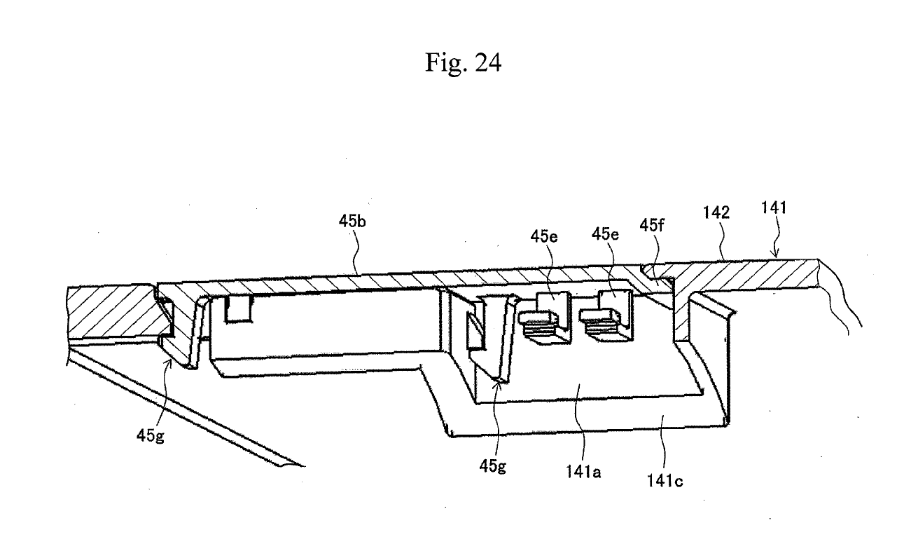

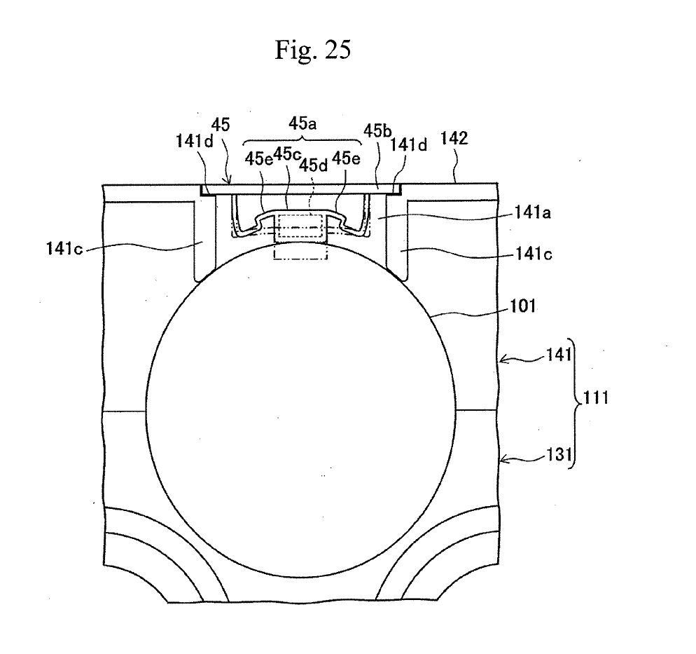

FIG. 20 are perspective views showing the upper holding frame member by enlarging a relevant part thereof, and FIG. 21 are perspective views showing the upper holding frame member from the reverse side, in which (A) in respective drawings is a view showing a state in which the temperature detection sensor 45 is attached and (B) is a view showing a state in which the temperature detection sensor is removed. FIG. 22 is a plan view showing the upper holding frame member by enlarging a relevant part thereof, FIG. 23 are perspective views explaining a structure of the temperature detection sensor, FIG. 24 is a perspective view showing a cross section in a state in which the temperature detection sensor is attached to the upper holding frame member, and FIG. 25 is a cross sectional view showing an attached state of the temperature detection sensor.

The temperature detection sensors 45 are attached to the upper holding frame member 141 of the holding case (holding member) 111 so that, for example, the temperature of the battery cell 101 arranged closest to the inlet side of cooling air (cooling medium) in the battery cell arrangement body 103U in the upper layer (refer to FIG. 9) and the temperature of the battery cell 101 arranged closest to the outlet side of cooling air of the battery cell arrangement body 103U in the upper layer are respectively measured. Although a case where temperatures of the battery cells 101 are measured by the temperature detection sensors 45 is explained as an example in the embodiment, if there is another battery cell 101 which can measure the maximum temperature and the lowest temperature of the battery cell 101, the temperature of another battery cell 101 can be measured.

The upper surface portion 142 of the upper holding frame member 141 faces outer peripheral surfaces (coated surfaces) of the battery cells 101 held by the holding case 111, in which cooling air is circulated therebetween. In the upper surface portion 142, a through hole 141a for attaching the temperature detection sensor 45 and a groove for wire rods 141b for wiring sensor wire rods of the temperature detection sensor 45 are formed as shown in FIGS. 20 to 22. The through hole 141a is formed so as to pierce the upper surface potion 142, having an opening shape of an approximately T-character shape in plan view particularly as shown in FIG. 22 and FIG. 20(B). The through hole 141a has a first opening portion corresponding to a cross-bar of the T-character and a second opening portion corresponding to a vertical-bar of the T-character. The first opening portion opens in a rectangular shape so as to extend along the longitudinal direction of the upper surface portion 142 at approximately the central position in the short side direction of the upper surface portion 142, and the second opening portion opens in a rectangular shape connecting from the center of a long edge of the first opening portion toward one side in the short side direction of the upper surface portion 142. In an end portion of the opening of the through hole 141a, a step surface 141d on which an end portion of a lid unit 45b of the temperature detection sensor 45 is overlapped and put is provided. The step surface 141d has approximately the same step size as a plate thickness of the lid unit 45b so that the lid unit 45b and the upper surface portion 142 are housed into the same plane.

Moreover, a peripheral wall portion 141c is formed inside the upper holding frame member 141 as shown, for example, FIG. 21, FIG. 24 and FIG. 25. The peripheral wall portion 141c is provided protruding from the upper surface 142 along the circumference of the through hole 141a over a space between the upper surface portion 142 and the outer peripheral surface of the battery cell 101 held in the holding case 111. The peripheral wall portion 141c forms a closed space portion inside the holding case 111 in conjunction with the temperature detection sensor 45 and the battery cell 101. The groove for wire rods 141b is formed in the upper surface portion 142 in a concaved manner so as to extend from the through hole 141a along the short side direction of the holding case 111.

The temperature detection sensor 45 is roughly divided into a sensor unit 45a and the lid unit 45b as shown, for example, FIG. 23. In the embodiment, the sensor unit 45a and the lid unit 45b are an integrated unit formed integrally. The sensor unit 45a can be easily fitted to a given position so as not to be deviated from the coated surface of the battery cell 101 by one assembly step of fitting the lid unit 45b into the through hole 141a of the upper holding frame member 141 at the time of assembling the cell block. It is also preferable that the sensor unit 45a is provided separately from the lid unit 45b to thereby support the sensor unit 45a in the lid unit 45b.

The lid unit 45b is a resin-molded body which is made of a flat-plate member having an approximately T-character shape closing the through hole 141a. The lid unit 45b includes a first lid portion having a rectangular shape corresponding to a cross-bar of the T-character and a second lid portion having a rectangular shape corresponding to a vertical bar of the T-character. In a long edge portion of the first lid portion on the side apart from the second lid portion, a tongue piece 45f to be engaged with an edge of the first opening portion of the through hole 141a is provided. Moreover, hooks 45g vertically extending from the flat-plate member and having protrusions 45h to be engaged with the edge of the through hole 141a at tips thereof are integrally formed in the first lid portion and the second lid portion. The hooks 45g are respectively formed at both end portions in the long-edge direction of the first lid portion and at both end portions in the short side direction of the second lid portion.

The sensor unit 45a has a structure of being supported by the lid unit 45b so as to be elastically deformed and being elastically deformed when the lid unit 45b closes the through hole 141a, and further, being pressed and contacted on the outer peripheral surface of the battery cell 110 due to reaction force of the elastic deformation. Specifically, as shown in FIG. 23 and FIG. 25, the sensor unit 45a includes a resin-molded sensor housing 45c, a thermistor device (temperature detection device) 45d arranged inside the sensor housing 45c, measuring the temperature of the battery cell 101 (subject) transmitted from a tip portion (contact portion with respect to the battery cell 101) of the sensor housing 45c to the inside and outputting an electric signal corresponding to the measured result, and elastic pieces 45e made of resin giving biasing force (reaction force by elastic deformation) to the sensor housing 45c by the elastic deformation and allowing the tip portion of the sensor housing 45c to be pressed and contacted on the outer peripheral surface of the battery cell 101.

The elastic pieces 45e are members bent in an L-character shape formed over a portion between side surfaces of the sensor housing 45c and inner faces of the flat-plate member of the lid unit 45b, and the sensor unit 45a is elastically supported in the lid unit 45b by four elastic pieces 45e as shown in FIG. 23. Two sensor wire rods 45j for outputting the electric signal of the thermistor device 45d are extended from the sensor unit 45a, which are housed and held in the groove for wire rods 141b. The sensor wire rods 45j are inserted into a bushing 45k. The bushing 45k seals between the groove for wire rods 141b and the through hole 141a by being fitted into the second opening portion of the through hole 141a, which is attached to the lid unit 45b so as to extend along the reverse surface of the first lid portion of the lid unit 45b. Not-shown connector terminals are provided at tips of the sensor wire rods 45j, which are connected to socket terminals provided in the voltage detection substrate.

The temperature detection sensor 45 having the above structure inserts the sensor unit 45a into the through hole 141a of the upper surface portion 142 from above the upper holding frame member 141 and engages the tongue piece 45f of the lid unit 45b with the edge of the first opening portion of the through hole 141a. Then, the lid unit 45b is further pressed to thereby allow the tip portion of the sensor housing 45c to be pressed and contacted on the coated surface of the battery cell 101, which bends the elastic pieces 45e by elastic deformation as well as engages the protrusions 45h of the hooks 45g with the edges of the first opening portion and the second opening portion of the through hole 141a. At this time, reaction force by the elastic deformation of the elastic pieces 45e biases the sensor housing 45c in a direction of pressing the sensor housing 45c onto the battery cell 101. Accordingly, the temperature detection sensor 45 is fixed to the upper holding frame member 141 in a state in which the through hole 141a is closed by the lid unit 45b, and the sensor housing 45c is held in a state in which the tip portion thereof is pressed and contacted on the coated surface of the battery cell 101 with a given pressing force.

According to the above structure of attaching the temperature detection sensor 45, the through hole 141a of the upper holding frame member 141 is closed by the lid unit 45b of the temperature detection sensor 45, therefore, it is possible to prevent cooling air from transmitting through the through hole 141a and flowing to the outside from the holding case 111 as well as prevent outside air from flowing into the holding case 111 from the outside. Therefore, the temperature of the battery cell 101 can be detected by the temperature detection sensor 45, and when gas is discharged from the battery cells 101, it is possible to prevent gas from transmitting through the through hole 141a and flowing into the holding case 111 from the outside and prevent gas from being mixed with cooling air.

Additionally, as the lid unit 45b of the temperature detection sensor 45 is attached to the upper surface portion 142 of the upper holding frame member 141 and the sensor unit 45a is elastically supported in the lid unit 45b, when external force is added to the temperature detection sensor 45 from above, the external force can be transmitted from the lid unit 45b to the upper holding frame member 141 and dispersed to the entire holding case 111 from the upper holding frame member 141 to be absorbed, which can prevent external force from being added to the sensor unit 45a and the battery cell 101.

According to the above structure of attaching the temperature detection sensor 45, the sensor housing 45c is housed in the closed space portion formed in cooperation of the peripheral wall portion 141c, the lid unit 45b and the battery cell 101, therefore, it is possible to prevent the sensor housing 45c from being exposed to cooling air flowing inside the holding case 111. Therefore, the temperature detection sensor 45 can detect the temperature of the battery cell 101 accurately.

The temperature detection sensor 45 has the bushing 45k into which the sensor wire rods 45j are inserted, having a structure in which the bushing 45k is fitted to the second opening portion of the through hole 141a to thereby seal between the through hole 141a and the groove for wire rods 141b, therefore, it is possible to positively prevent cooling air from flowing out from the holding case 111 and to prevent outside air from flowing into the holding case 111 when the cooling air is transmitted between the through hole 141a and the groove for wire rods 141b.

In the structure in which the elastic locking piece of the temperature sensor is engaged with an peripheral edge portion of an attachment hole and elastically deformed as shown in, for example, Patent Document 1, there is a potential that larger external force than given pressing force is added to the battery cell when external force is added to the temperature sensor.

In response to this, when the above structure of attaching the temperature detection sensor 45 is applied, the sensor unit 45a is supported in the lid unit 45b so as to be elastically deformed, therefore, for example, when external force is added to the lid unit 45b of the temperature detection sensor 45, the external force can be transmitted from the lid unit 45b to the holding case 111 to be dispersed and absorbed in the holding case 111, which can prevent the external force from being added to the sensor unit 45a and the battery cell 101.

### <Shutter Structure>

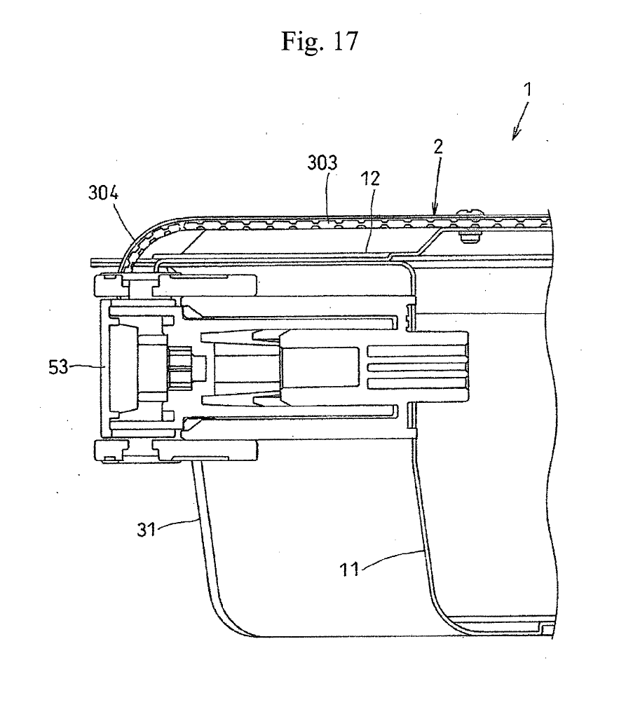

Next, a structure of the upper lid portion 12 according to the embodiment will be explained in detail with reference to FIG. 16 and FIG. 17.

FIG. 16 are perspective views explaining a shutter structure provided on the upper lid portion and FIG. 17 is a view of a cross section taken along XVII-XVII line of FIG. 16 (a) seen from arrows. FIG. 16 (a) shows a closed state of a shutter and FIG. 16 (b) shows an opened state of the shutter.

An upper lid opening 12a connecting to the module casing 2 is formed in the upper lid portion 12 of the module casing 2, and a sliding shutter 301 for opening and closing the upper lid portion 12a is provided.

The shutter 301 includes a flat-plate portion 302 supported so as to reciprocate in an opening direction and a closing direction along an upper surface of the upper lid portion 12 and a slat portion 303 continuously extended from an end portion on the opening direction side of the flat-plate portion 302.

The flat-plate portion 302 is supported so as to be selectively arranged at an opened position where the upper lid opening 12a is opened and at a closed position where the upper lid opening 12a is closed, opening the upper lid opening 12a to expose an inverter connection terminal 311 inside the casing 2 when the flat-plate portion 302 is arranged at the opened position shown in FIG. 16 (b). Then, when the flat-plate portion 302 is arranged at the closed position shown in FIG. 16 (a), the flat-plate portion 302 covers the inverter connection terminal 311 by closing the upper lid opening 12a.

Also in the flat-plate portion 302, a window hole 302a is provided, thereby covering a safety bolt 312 at positions other than the opened position and exposing the safety bolt 312 at the opened position. The safety bolt 312 forms one of plural bolts 5 for fastening the upper lid portion 12 to the lower lid portion 11, which prevents removal of the upper lid portion 12 unless the fastening is released.

The slat portion 303 is guided by a rail portion 304 so as to change the movement direction to the lower direction at a rear end edge of the upper lid portion 12 when moved in the opening direction.

In a state in which the flat-plate portion 302 of the shutter 301 is arranged in the closed position, a connector 53a of the SD switch 53 is attached so as to be detachable at a position facing a portion on the opening side in the movement direction of the slat portion 303, therefore, it is difficult to move the flat-plate portion 302 from the closed position to the opened position unless the connector 53a is removed. The SD switch 53 has a structure of shutting off electrical connection between the second cell block 42 and the third cell block 43 by removing the connector 53a.

According to the shutter structure having the above structure, the shutter 301 is held in the closed position and it is difficult to move the shutter 301 to the opening direction in the state in which the connector 53a of the SD switch 53 is attached. Therefore, it is possible to prevent the inverter connection terminal 311 and the safety bolt 312 from being exposed to the outside in the state in which the electrical connection between the second cell block 42 and the third cell block 43 is maintained.

Accordingly, it is possible to prevent that operators and the like accidentally touch the inverter connection terminal 311 in the connection state as well as prevent that the upper lid portion 12 is removed from the lower lid portion 11 due to the release of fastening of the safety bolt 312. Therefore, operations such as maintenance are surely performed in a state in which electricity is shut off, which secures safety of operators.

### <Module Casing>

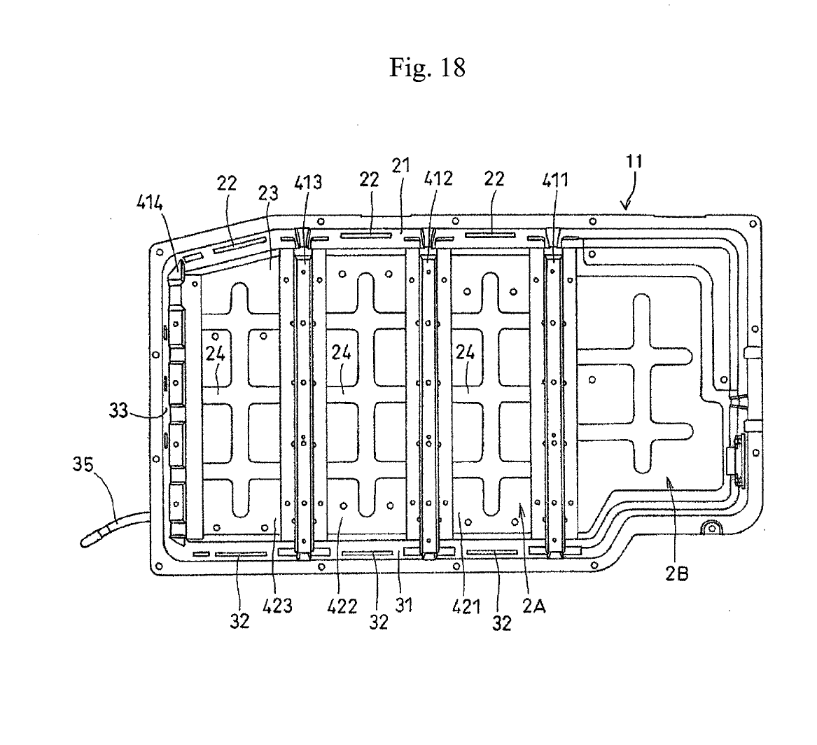

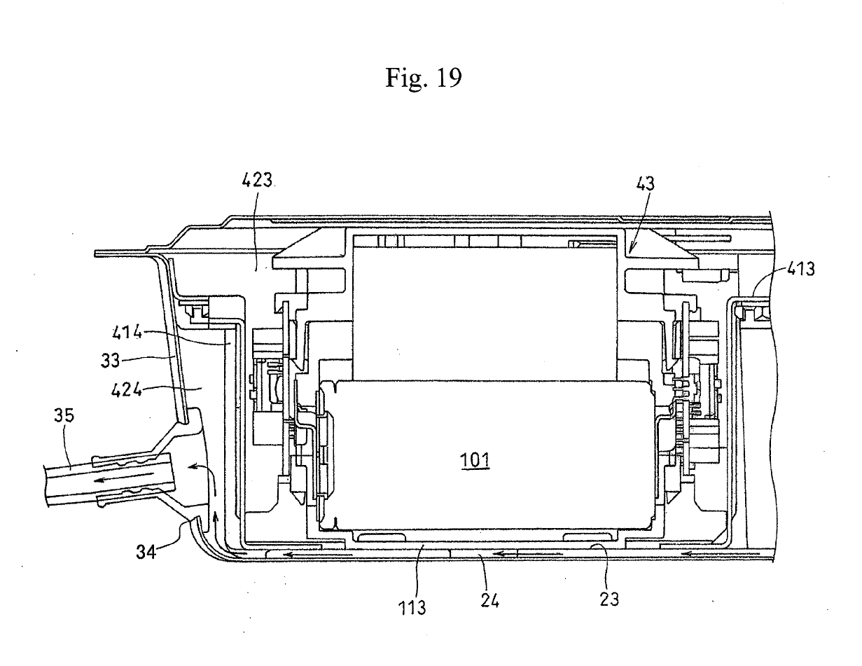

Next, a structure of the module casing 2 according to the embodiment will be explained in detail with reference to FIG. 18 and FIG. 19.

FIG. 18 is a plan view of the lower lid portion of the module casing and FIG. 19 is a view showing a relevant part of a rechargeable battery module in a cross section.

In the lower lid portion 11, four ribs 411 to 414 extending in the front and rear direction with given intervals in the lateral direction are provided. The respective ribs 411 to 414 are provided to stand on a casing bottom wall portion 23 extending in a flat state between the casing front-wall portion 21 and the casing rear-wall portion 31 of the lower lid portion 11. In the four ribs 411 to 414, the first rib 411 sections the inside of the lower lid portion 11 into one side in the lateral direction and the other side in the lateral direction, thereby forming the battery unit housing area 2A housing the battery unit 3 and the control unit housing area 2B housing the control unit 4 (middle-wall rib).

The second rib 412 and the third rib 413 section the battery unit housing area 2A into three cell-block housing chambers, forming a first housing chamber 421 which can house the first cell block 41 between the first rib 411 and the second rib 412 and forming a second housing chamber 422 which can house the second cell block 42 between the second rib 412 and the third rib 413 (middle-wall ribs).

The fourth rib 414 is provided along a casing side wall portion 33, forming a third housing chamber 423 which can house the third cell block 43 between the third rib 413 and the fourth rib 414 (side-wall rib).

Screw holes for fixing a cell-block bracket 91 (refer to FIG. 2) are provided above the respective ribs 411 to 414. The cell-block bracket 91 fixes the cell blocks 41 to 43 by respectively pressing the cell blocks 41 to 43 housed in respective housing chambers 421 to 423 from above and by regulating vertical movement thereof, which is fastened above the respective ribs 411 to 412 by screws.

As shown in FIG. 19, a gas discharge chamber 424 having a given chamber space is formed between the fourth rib 414 and the casing side wall portion 33. In the casing side wall portion 33, a gas discharge port 34 is opened, to which a gas exhaust duct 35 is connected.

Then, as shown in FIG. 18, the air inlets 22 of the casing front-wall portion 21 and the exhaust ports 32 of the casing rear-wall portion 31 are respectively formed in pairs at a position corresponding to respective housing chambers 421 to 423. The respective cell blocks 41 to 43 are housed in a state in which movement in the lateral direction is suppressed by the ribs 411 to 414.

In the casing bottom wall portion 23 in the lower lid portion 11, as shown in FIG. 19, a plural number of shallow groove portions 24 are provided. The respective shallow groove portions 24 are formed, for example, by allowing the lower lid portion 11 to protrude downward from the casing bottom wall portion 23 when the lower lid portion 11 is press-formed. The respective shallow groove portions 24 are provided so as to extend in the front and rear direction as well as in the lateral direction in a manner of crossing each other. The shallow groove portions 24 extending in the lateral direction continue from the first housing chamber 421 to the third housing chamber 423, which are connected to the gas discharge chamber 424 formed between the fourth rib 414 and the casing side wall portion 33.

When gas is discharged from at least one battery cell 101 in the respective cell blocks 41 to 43 housed in the respective housing chamber 421 to 423, the shallow groove portions 24 can allow the gas to transmit in the flow direction shown by arrows in FIG. 19 to flow into the gas discharge chamber 424. The gas flowing into the gas discharge chamber 424 is discharged to the outside of the module casing 2 through the gas exhaust duct 35.

According to the above structure, as the shallow groove portions 24 are formed so as to continue from the first housing chamber 421 to the third housing chamber 423, and end portions of the shallow groove portions 24 are connected to the gas discharge chamber 424, when gas is discharged from at least one battery cell 101 in the respective cell blocks 41 to 43 housed in the respective housing chamber 421 to 423, it is possible to allow the gas to transmit through the shallow groove portions 24 and to circulate to the gas discharge chamber 424, therefore, the gas can be discharged from the gas discharge chamber 424 to the outside of the module casing 2. Therefore, it is possible to prevent the gas discharged in the module casing 2 from being stayed inside the module casing 2 and entering into the holding case 61 of the cell block 40, for example, from between the casing front-wall portion 21 and the case front-end face portion 62, or transmitting between the casing rear-wall portion 31 and the case rear-end face portion 64 and being discharged from the exhaust ports 32 of the casing rear-wall portion 31.

Additionally, the shallow groove portions 24 are provided in the casing bottom wall portion 23 so as to extend in the front and rear direction as well as in the lateral direction, and the first rib 411 to the forth rib 414 are provided so as to extend in the front and rear direction, therefore, high rigidity of the lower lid portion 11 can be obtained and deformation of the module casing 2 can be prevented.

The present invention is not limited to the above embodiment and various alternations may occur within a scope not departing from the gist of the invention. For example, the case where the space areas 80A, 80B are formed by interposing the duct member 71 between the casing front-wall portion 21 and the case front-end face portion 62 has been explained as an example in the above embodiment, however, it is also preferable that the space areas are formed by interposing duct member between the casing rear-wall portion 31 of the module casing 2 and the case rear-end face portion 64 of the cell block 40. Moreover, the case where the cell block 40 has two layers of the battery cell arrangement body 103U in the upper layer and the battery cell arrangement body 103L in the lower layer has been explained as an example in the above embodiment, however, the cell block 40 may include three layers or more.

### REFERENCE SIGNS LIST

1 lithium-ion battery device (Storage battery device)
45 temperature detection sensor
45a sensor unit
45b lid unit
45c sensor housing
45d temperature detection device (thermistor device)
45e elastic piece
45j sensor wire rod
45k bushing
101 battery cell (storage battery)
111 holding case (holding member)
142 upper surface portion (facing surface portion)
141a through hole
141b groove for wire rods
141c peripheral wall portion

1. A power storage device comprising:
a holding member holding power storage units; and
at least one temperature detection sensor detecting temperature of the power storage units held by the holding member,
wherein the holding member includes
a facing surface portion facing coated surfaces of the power storage units held by the holding member, and
at least one through hole formed so as to pierce through the facing surface portion,
the temperature detection sensor includes
a lid unit closing the through hole by being attached to the holding member, and
a sensor unit supported in the lid unit so as to be elastically deformed, which is elastically deformed when the lid unit closes the through hole, pressed and contacted onto the coated surface of the power storage unit due to reaction force of elastic deformation,
wherein the sensor unit includes
a sensor housing having a temperature detection device, and
elastic pieces extended from the sensor housing and supported in the lid unit, and
wherein the holding member includes
a groove for wire rods formed on the facing surface portion so as to connect to the through hole, in which sensor wire rods of the temperature detection device are wired, and
the temperature detection sensor has a bushing into which the sensor wire rods of the temperature detection device are inserted, sealing between the through hole and the groove for wire rods.

2. The power storage device according to claim 1,
wherein the holding member includes a peripheral wall portion which is provided protruding from the facing surface portion along the circumference of the through hole over a space between the facing surface portion and the coated surface of the power storage unit.

3. (canceled)

4. (canceled)

5. The power storage device according to claim 2,
wherein the sensor unit includes
a sensor housing having a temperature detection device, and
elastic pieces extended from the sensor housing and supported in the lid unit.

6. The power storage device according to claim 5,
wherein the holding member includes
a groove for wire rods formed on the facing surface portion so as to connect to the through hole, in which sensor wire rods of the temperature detection device are wired, and
the temperature detection sensor has a bushing into which the sensor wire rods of the temperature detection device are inserted, sealing between the through hole and the groove for wire rods.
